(19) United States
(12) Patent Application Publication
(10) Pub. No.: US 2006/0089892 A1
(43) Pub. Date: Apr. 27, 2006

(54) Methods and apparatus for investment portfolio selection, allocation, and management to generate sustainable withdrawals

(76) Inventors: Peter A. Sullivan, East Greenwhich, RI (US); Frank P. McGoff, East Greenwhich, RI (US); David A. Nabb, Woonsocket, RI (US); Ronald E. Tanguay, Johnston, RI (US)

Correspondence Address: Steven M. Santisi, 80 Lounsbury Ln, Ridgefield, CT, 06877, US

(21) Appl. No.: 10/974,196

(22) Filed: Oct. 27, 2004

(51) Int. Cl. G06Q 40/00

(52) U.S. Cl. 705/35

(57) ABSTRACT

Methods and apparatus are provided for determining a minimum distribution rate and an investment allocation among individual investments of different types, including income generating investments that may be counter-balanced by principal protection investments, according to predefined ratios, determining a distribution amount based upon a performance level of individual investments and the minimum distribution rate, and determining at least a portion of individual investments to liquidate to fund the distribution amount. The minimum distribution rate is greater than a predefined percentage of a current value of the investment per year and is maintained at a level at least equal to a highest level of all prior years. The present invention further provides distribution types that allow selection of a distribution method that best suits an investor's requirements. The distribution type selection provides methods for determining the amount of a distribution for a given period and how the distribution is to be funded.

### FIELD OF THE INVENTION

The present invention relates generally to financial investment management, and more specifically, to methods and apparatus for determining investment allocations and sustainable withdrawals.

### BACKGROUND

An increasing percentage of the population is seeking a financial management solution for retirement. While much has been written about the aging generation of World War II “baby boomers” (those individuals born from 1946 through 1964) and their focus on retirement, this issue affects a broader population. Currently, 12% of today's population is over the age of 65 and, by 2030, this percentage is projected to grow to approximately 20%. Beginning in 2008, approximately 3.8 million baby boomers are expected reach age 62. Baby boomers, in many cases, are more affluent and formally educated than their parents' generation. A significant concern of these baby boomers and all retirees is the disappearance of traditional pension programs and potential reductions in Social Security coverage and payments.

Currently, there are several products that attempt to offer solutions to retirees' or pre-retirees' need for an investment-based income generation solution. However, these products fall short of providing people with the means to use existing savings to create a sustainable, reliable income stream. For example, retirement calculators, on-line websites, expense estimators and traditional advisory services offer complex and often contradictory advice that can be expensive upfront and even more expensive if the information is misapplied. Traditional retirement products such as annuities, CD's, TIPS, bond funds, reverse mortgages, mutual fund dividend withdrawals and generic stock, bond and cash portfolios with a 4% annual withdrawal rate, include their own set of pitfalls but generally fall short in that they are either too risky or too conservative. Some of these products require the client to give up control of their principal balances for an extended period of time (i.e. CDs) or, as in the case with certain annuity products, to give up complete rights to any remaining principal at the termination of the contractual term. What is needed is a product which allows the client/investor to retain the full ability to regain total control over their investment dollars or, upon the death of the client(s), to turnover the existing (and hopefully increased) principal balances to their heirs. Additionally, existing products are designed to only provide a partial answer to the end client. A specific or total solution to the question, “What will a client's income be once retired?” is not provided by existing products. An investor in such products is typically not able to gain an intuitive understanding of the level of risk involved, nor an opportunity to test such investments against the realistic worst case market scenarios that one is likely to face in the next forty years.

Today's retirees and pre-retirees have had access to safer working conditions, better nutrition and more modern medical techniques than previous generations. It is no surprise that their life expectancies have increased and are anticipated to continue to increase. Therefore, the retirement income solution they select must work for a much longer time period than those approaches utilized by previous generations. Many current projections assume that a healthy retiree at age 65 could expect to live for 20 or 30 years after retirement.

Prior, conventional investment strategies have maintained that the closer an individual gets to retirement, the more their investments should shift toward a defensive or a less risky portfolio. Thus, investments in bond or fixed income portfolios have been traditionally utilized for a majority of a retiree's income. These types of portfolios accept the decrease in real purchasing power due to the impact of inflation as an acceptable trade off for the specific and known amount of pre-tax income provided by this strategy in the short run.

Given that today's retirees are expected to live longer than previous generations, a dependence on fixed income portfolios will generate an income stream which will see a steady long term decrease in real purchasing power over the life of the retirees. Therefore, the previously accepted or traditional investment strategy (i.e. low risk) needs to be changed to deal with the new reality of longer post retirement periods. Thus, there is a substantial and growing need for an investment solution that can generate a sustainable, reliable, and increasing income stream over an extended period of time while, at the same time, growing the individual's principal balances as well. This need is also felt by organizations such as non-profit groups, educational institutions, and for profit corporations such as insurance companies, etc.

The annual rate of planned withdrawals from an income producing investment significantly impacts a portfolio's ability to endure long enough to serve a retiree. Conventional thought is that an annual withdrawal rate greater than 4% per year (adjusted upwards for inflation each year) is not sustainable even with a well balanced portfolio, and that a rate greater than 6% per year cannot last more than 20 years. Thus, based upon conventional theory, an investor is significantly restricted in the size of the annual withdrawal amount a traditional financial advisor would recommend.

What is needed are systems and methods to facilitate an investment allocation that is capable of generating a sustainable, increasing income stream based on a withdrawal rate significantly greater than the conventional 4% per year rate within acceptable risk parameters.

### SUMMARY OF THE INVENTION

The present invention overcomes the above and other drawbacks of the prior art by offering systems and methods for management of financial investments that generate a sustainable and increasing income stream even in declining and fluctuating market conditions.

In a first aspect, the present invention includes determining an investment amount for purchasing an investment and a minimum distribution rate, allocating the investment amount among investments of different types, determining a distribution amount based upon a performance level of the individual investments and the minimum distribution rate, and determining an individual investment from among the investments to liquidate to fund the distribution amount. The minimum distribution rate may be greater than a predefined percentage of a current value of the investment per year and is maintained at a level at least equal to a highest level of all prior years.

In a second aspect, the present invention includes determining an investment amount and a minimum distribution rate, allocating the investment amount among investments of different types, determining a distribution amount based on a predefined periodic adjustment and independent of a performance level of the plurality of investments, and determining a portion of an investment from among the investments to liquidate to fund the distribution amount. The minimum distribution rate may be greater than a predefined percentage of the investment amount per year.

In a third aspect, the present invention includes selecting investments having contrary investment philosophies, investing an amount in the contrary investments, reinvesting, over time, any earnings from the investments back into the investments, determining, periodically, a distribution amount that is greater than or equal to a prior period's distribution amount, selling a portion of the investments sufficient to fund the distribution amount if the determined amount is greater than the prior period's distribution amount, and selling a portion of the investments based on any growth in the investments to fund a first part of the distribution amount and selling a portion of a different investment sufficient to fund a second part of the distribution amount such that the first part and second part sum to equal the determined distribution amount if the investments are worth less than the determined distribution amount.

In a fourth aspect, the present invention includes investing in income generating investments and principal protection investments, and drawing a periodic distribution amount from the investments based upon a withdrawal percentage of the value of the income generating investments. The periodic distribution amount may be equal to or greater than all prior periodic distribution amounts. The distribution may be funded first by selling a portion of the income generating investments, and second by selling a portion of the principal protection investments if the withdrawal percentage of each of the income generating investments combined are insufficient to fund the periodic distribution amount.

In a fifth aspect, the present invention includes determining an investment amount for purchasing an investment, determining a minimum distribution rate, allocating the investment amount among a plurality of individual investments of different types based upon predefined ratios and historical performance information, determining a distribution amount based upon a performance level of individual investments and the minimum distribution rate, and determining a portion of an individual investment from among the investments to liquidate to fund the distribution amount. The minimum distribution rate may never decreased and the distribution amount may be paid out indefinitely as long as the investment performs no worse than the historical performance information indicates.

With these and other advantages and features of the invention that will become hereinafter apparent, the nature of the invention may be more clearly understood by reference to the following detailed description of the invention, to the appended claims and to the several accompanying drawings attached hereto.

### BRIEF DESCRIPTION OF THE DRAWINGS

FIG. 1 is a block diagram illustrating an example of a system according to some embodiments of the present invention.

FIG. 2 is a block diagram illustrating an example of an alternative system according to some embodiments of the present invention.

FIG. 3 is a block diagram illustrating an example of a controller as depicted in FIGS. 1 and 2 according to some embodiments of the present invention.

FIG. 4 is a table illustrating an example data structure of an example historical net asset value (NAV) database as depicted in FIG. 3 for use in some embodiments of the present invention.

FIG. 5 is a table illustrating an example data structure of an example investments database as depicted in FIG. 3 for use in some embodiments of the present invention.

FIG. 6 is a table illustrating an example data structure of an example portfolio performance database as depicted in FIG. 3 for use in some embodiments of the present invention.

FIG. 7 is a table illustrating an example data structure of an example results summary database as depicted in FIG. 3 for use in some embodiments of the present invention.

FIG. 8 is a flow diagram illustrating a first exemplary process according to and for use in some embodiments of the present invention.

FIG. 9 is a flow diagram illustrating a second exemplary process according to and for use in some embodiments of the present invention.

FIG. 10 is a flow diagram illustrating a third exemplary process according to and for use in some embodiments of the present invention.

FIG. 11 is a flow diagram illustrating a fourth exemplary process according to and for use in some embodiments of the present invention.

FIG. 12 is a flow diagram illustrating a first exemplary process for determining a periodic distribution amount according to and for use in some embodiments of the present invention.

FIG. 13 is a flow diagram illustrating a first exemplary process for funding a periodic distribution amount according to and for use in some embodiments of the present invention.

FIGS. 14A & 14B are a flow diagram illustrating a second exemplary process for determining a periodic distribution amount according to and for use in some embodiments of the present invention.

FIG. 15 is a flow diagram illustrating a second exemplary process for funding a periodic distribution amount according to and for use in some embodiments of the present invention.

FIG. 16 is a flow diagram illustrating a third exemplary process for determining a periodic distribution amount according to and for use in some embodiments of the present invention.

FIG. 17 is a flow diagram illustrating a third exemplary process for funding a periodic distribution amount according to and for use in some embodiments of the present invention.

FIG. 18 is a flow diagram illustrating a fourth exemplary process for determining a periodic distribution amount according to and for use in some embodiments of the present invention.

FIG. 19 is a flow diagram illustrating a fourth exemplary process for funding a periodic distribution amount according to and for use in some embodiments of the present invention.

FIG. 20 is a table comparing different distribution method types according to and for use in some embodiments of the present invention.

FIG. 21 is a graph comparing different distribution method types according to and for use in some embodiments of the present invention.

FIG. 22 is a table illustrating the performance of an example investment portfolio using historical data according to and for use in some embodiments of the present invention.

FIG. 23 is a graph depicting an example of growth of an investment according to some embodiments of the present invention.

FIG. 24 is a graph depicting an example of growth of an annual distribution amount according to some embodiments of the present invention.

FIG. 25 is a graph depicting an example of growth of a monthly distribution amount according to some embodiments of the present invention.

### DETAILED DESCRIPTION

In the following description, reference is made to the accompanying drawings that form a part hereof, and in which is shown by way of illustration, specific embodiments in which the invention may be practiced. These embodiments are described in sufficient detail to enable those skilled in the art to practice the invention, and it is to be understood that other embodiments may be utilized and that structural, logical, hardware, software, mechanical, and electrical changes may be made without departing from the scope of the present invention. The following description is, therefore, not to be taken in a limited sense, and the scope of the present invention is defined by the appended claims. Note that although most components or elements are referenced using a reference numeral whose most significant digit (or digits) correspond to the figure number within which they appear, components or elements appearing in more than one figure are referenced using the reference numeral with which they were first identified.

The inventors of the present invention have recognized that a need exists for an improved, sustainable income generation solution. It is an object of the present invention to provide a methodology that will safely, systematically, and routinely provide a predictable income stream from a long term investment.

As indicated above, it is clear that dependence on fixed income portfolios alone will not suffice to avoid a decrease in purchasing power over a retirees' life assuming that retirees will live longer than previous generations. Therefore, conventional (i.e. low risk) retirement investment strategy should be adapted to accommodate the reality of longer post retirement periods. The inventors of the present invention have determined that a new strategy or approach should be weighted primarily towards equities to provide the required continued growth in value over an extended retirement period. The present inventors have determined that such an approach can support the continued long term appreciation in principal balances needed to provide increasing levels of income and to offset the effects of inflation. In some embodiments, the present invention uses a balanced, diversified investment strategy to provide a maximized but steady income stream over a period of at least thirty to forty years that does not decrease year to year. The present invention provides a guideline for allocation of investment resources across a number of investments having varied styles. According to the present invention, a diversified plurality of income generating investments may be counter-balanced and individually supported by one or more principal protection investments. In other words, for a given income generating investment failing to perform in a given period, the share of periodic distribution associated with that investment may be funded via liquidation of a portion of a principal protection investment.

The present invention further provides an array of distribution types that allow an investor (or advisor) to select a distribution method that best suits the investor's requirements. The distribution type selection provides methods in accordance with the present invention for determining the amount of a distribution for a given period and how the distribution is to be funded. More specifically, in some embodiments, the distribution type selection may be used to determine how much of a raise an investor is to receive in any given year and which investments (and how much) are to be sold to fund the distribution. The present invention further provides that if the selected distribution method and initial allocation guidelines are followed, the investment will, with a very high probability, continue to generate income for as long as the market does not experience cumulative conditions less favorable than experienced during a historical time period of equal length extending backward from the inception of the investment. In other words, the present invention can provide a steady, non-decreasing income stream indefinitely if the market performs no worse than it has in the past.

The present invention further provides software tools, including database structures, adapted to present the results of applying the initial allocation guidelines and various distribution methods to historical data. An example embodiment of computer code that implements such software tools is provided in the Appendix attached hereto and included as part of the present detailed description of the invention. Note that the computer code of the Appendix is written in Microsoft® Visual Basic as a Microsoft® Access Database Application.

In addition to retirees, the present invention is also applicable to meeting the income needs of other groups and organizations such as non-profit groups, educational institutions, and for profit corporations such as insurance companies, etc. who have financial assets or endowment funds from which a predictable and growing income stream is needed over a long term.

The present invention avoids storing income and selling investments that are performing better than average. From the inception of an investment plan based on the present invention, total assets may be put to work for income generation. These assets may be placed in an arrangement from as conservative as 81% income generating and 19% principal protection, to as assertive as 90% income generating and 10% principal protection. The withdrawal percentage may be set comfortably anywhere between 6.5% to 8%. Income is withdrawn from the income generating investments from inception. The present invention does not require that earnings be saved for future support of the income stream.

The present invention does not attempt to “time” the market. The present invention systematically withdraws shares of all funds to produce income and reinvest all dividends as they are paid. The taxation of dividends is the same in a non-qualified account whether paid out as cash or reinvested. Therefore, when an income percentage is determined according to the present invention, it is only altered in accordance with predefined algorithms and there is no attempt to time the market. All funds not used as withdrawals remain invested to generate income. The present invention takes advantage of the fact that the repeated dollar cost averaging of shares remaining invested in a broad sense will rise remarkably over time. Therefore, the present invention does not attempt to liquidate assets that are performing above average at a particular point in time to try to maximize gains.

The present invention employs several investment styles to create a balancing factor that does not require active tactical rebalancing. Excessive rebalancing in accounts holding non-qualified monies increases costs to clients. Rebalancing also generates reportable gains that trigger unnecessary short and/or long term capital gains taxes.

### A. TERMS

Throughout the description that follows and unless otherwise specified, the following terms may include and/or encompass the example meanings provided in this section. These terms and illustrative example meanings are provided to clarify the language selected to describe embodiments of the invention both in the specification and in the appended claims.

The terms “products,” “goods,” “merchandise,” and “services” shall be synonymous and may refer to anything licensed, leased, sold, available for sale, available for lease, available for licensing, and/or offered or presented for sale, lease, or licensing including packages of products, subscriptions to products, contracts, information, services, intangibles, and investments.

The term “merchant” may refer to an entity who may offer to sell, lease, and/or license one or more products to a consumer (for the consumer or on behalf of another) or to other merchants. For example, merchants may include sales channels, individuals, agents, companies, manufacturers, distributors, direct sellers, re-sellers, service providers, advisors, and/or retailers. Merchants may transact out of buildings including stores, outlets, malls, and warehouses, and/or they may transact via any number of additional methods including mail order catalogs, vending machines, online web sites, and/or via telephone marketing. Note that a producer or manufacturer may choose not to sell to customers or service clients directly and in such a case, a retailer or distribution outlet may serve as the manufacturer's or producer's sales channel.

The terms “distribution outlet” and “DO” shall be synonymous and may refer to a select merchant who has met rigorous standards and requirements to qualify to employee advisors to practice methods of the present invention to serve clients. Distribution outlets may include banks, CPA firms, law firms, brokerage firms, financial planning firms, investment managers, insurance firms, hybrid firms, and the like.

The term “advisor” may refer to an employee or operator of a distribution outlet that has been specifically trained to practice methods of the present invention to serve clients. In some embodiments, advisors may be required to pass an exam and/or otherwise qualify or be certified to practice methods of the present invention.

The terms “server” and “controller” shall be synonymous and may refer to any device that may communicate with one or more operator terminals, one or more third-party servers, one or more user devices, one or more distribution outlet devices, and/or other network nodes, and may be capable of relaying communications to and from each. Servers may include facilities to support secure communications using encryption or the like. In some embodiments, distribution outlet advisors may employ one or more controllers to automate or partially automate the servicing of clients.

The terms “operator terminal” and “remote controller” shall be synonymous and may refer to any device that may communicate with one or more servers, one or more user devices, one or more distribution outlet devices, one or more third-party service provider servers, and/or other network nodes. In some embodiments, operator terminals may, for example, include personal computers, laptop computers, handheld computers, telephones, kiosks, personal digital assistants, point-of-sale terminals, point of display terminals, cellular phones, automated teller machines (ATMs), pagers, game consoles, vending machines, and/or combinations of such devices. They may include facilities to support secure communications using encryption or the like.

The terms “user device⇄ or “client device” shall be synonymous and may refer to any device owned or used by users/clients/potential clients capable of accessing and/or displaying online and/or offline content. User devices may communicate with one or more servers, one or more distribution outlet devices, one or more third-party service provider servers, one or more operator terminals, and/or other network nodes. In some embodiments, user devices may, for example, include personal computers, laptop computers, handheld computers, telephones, kiosks, personal digital assistants, point-of-sale terminals, point of display terminals, cellular phones, automated teller machines (ATMs), pagers, game consoles, vending machines, and/or combinations of such devices. User devices may include facilities to support secure communications using encryption or the like.

The terms “distribution outlet device,” “DO device,” and “advisor device” shall be synonymous and may refer to a device that may be capable of receiving instructions from an advisor and of communicating instructions to a server or controller. The instructions may indicate investments to sell, pricing information, benefits, offers, promotions, non-commercial messages, and NAV data. In some embodiments, distribution outlet devices may, for example, include personal computers, laptop computers, handheld computers, telephones, kiosks, personal digital assistants, point-of-sale terminals, point of display terminals, cellular phones, automated teller machines (ATMs), pagers, game consoles, vending machines, and/or combinations of such devices. Distribution outlet devices may include facilities to support secure communications using encryption or the like.

The term “input device” may refer to a device that is used to receive an input. An input device may communicate with or be part of another device such as a point of sale terminal, a point of display terminal, a user device, a server (e.g., a pressure sensor in a keyboard of a computer), an operator terminal, a controller, etc. Some examples of input devices include: a bar-code scanner, a magnetic stripe reader, a computer keyboard, a point-of-sale terminal keypad, a touch-screen, a microphone, an infrared sensor, a sonic ranger, a computer port, a video camera, a motion detector, a digital camera, a network card, a universal serial bus (USB) port, a GPS receiver, a radio frequency identification (RFID) receiver, an RF receiver, a thermometer, a pressure sensor, and a weight scale.

The term “output device” may refer to a device that is used to output information. An output device may communicate with or be part of another device (e.g., a user device, a point of sale terminal, a point of display terminal, a controller, etc.). Some examples of output devices include: a cathode ray tube (CRT) monitor, liquid crystal display (LCD) screen, light emitting diode (LED) screen, a printer, an audio speaker, an infra-red transmitter, a radio transmitter.

The terms “I/0 device” and “input/output device” shall be synonymous and may refer to any combination of input and/or output devices.

The terms “downside deviation” and “downside risk” shall be synonymous and may refer to an alternate measure of risk to standard deviation. The concept of downside risk assumes that each investor has a Minimal Acceptable Return, (MAR), and that the investor is only concerned with deviations below this MAR. Unlike standard deviation, if the investor's investment realizes a return above the MAR, then the return is observed as acceptable and should not be indicative of risk. In a downside variance framework, only deviations below the MAR are considered when computing the measure of risk.

The term “Sortino Ratio” may refer to a measure that is similar to the standard Sharpe Ratio, but provides risk-adjusted return information in a different risk framework. The numerator is similar to the standard Sharpe Ratio, except that instead of the risk free rate, the investor's minimal acceptable return (MAR) is used. Also, where the Sharpe Ratio uses standard deviation in the denominator, the Sortino uses a measure of semi-deviation called Downside Risk. Essentially what the Sortino ratio provides is a measure of how far the manager's returns are above the MAR relative to the amount of Downside Risk he or she is taking. Note that the Sortino Ratio is not the same as the Upside Potential Ratio. The Upside Potential Ratio uses a probability-weighted function of returns.

The term Θupside potential ratio” may refer to a measure of the ability to exceed an investor's minimal acceptable return (MAR) relative to the amount of downside risk he or she is taking. It is the ratio of Upside Potential to Downside Risk. Using the Upside Potential Ratio provides a unitless number that indicates how likely you are to experience returns above the MAR while accounting for the risk of experiencing returns below the MAR. For example, an Upside Potential Ratio of 1.5 means your chances for success (getting a return above the MAR) are 50% higher than your risk of failure (getting a return below the MAR).

The term “downside risk-adjusted return” (DS RAR) may refer to the return of a portfolio after being adjusted for downside risk. It is calculated by taking the return earned, measured as a fraction, minus a risk tolerance variable multiplied by the downside variance (or downside risk squared). The value of risk tolerance depends on the investor's degree of risk aversion. In M-Search, a value of 3.0 is used because it is the average risk-averse measure for the average investor (as determined by the Pension Research Institute). With the M-Search Style Analysis option, you can set a value for risk tolerance ranging from 2.0 to 4.0 (with 2.0 being aggressive and 4.0 being conservative).

### B. SYSTEM

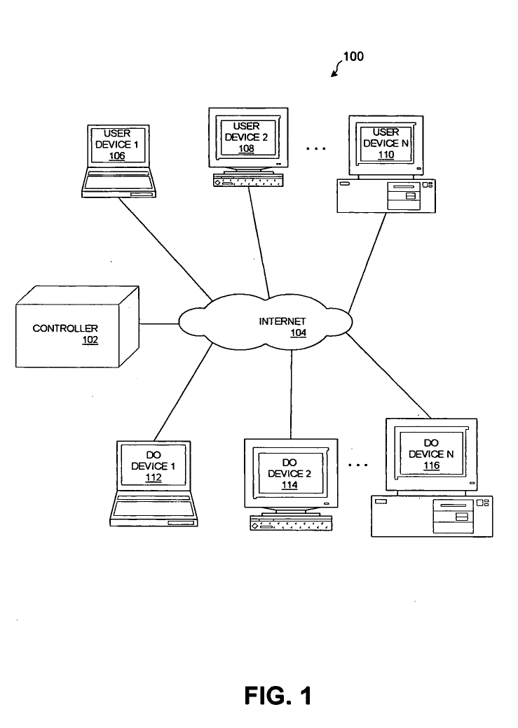

Referring now to FIG. 1, a system 100 according to some embodiments of the present invention includes a controller 102 that is in one or two-way communication via the Internet 104 (or other communications link) with one or more user devices 106, 108, 110, and/or distribution outlet devices 112, 114, 116. In operation, the controller 102 may function under the control of a distribution outlet, merchant, or other entity that may also control or own the user devices 106, 108, 110. For example, the controller 102 may be a server in a bank's ATM network, a server in an insurance company's branch office network, and/or a server in a merchant's vending machine network. In some embodiments, the controller, the user devices, and/or the DO devices may be one and the same.

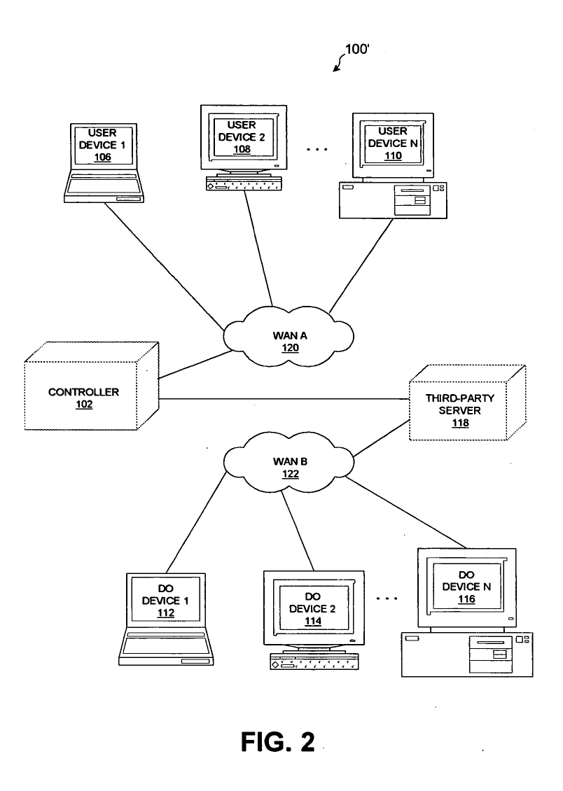

Referring to FIG. 2, an alternative system 100′ according to some embodiments of the present invention further includes one or more third-party service provider servers 118. A third-party service provider server 118, or third-party server 118, may also be in one or two-way communication with the controller 102. However, as shown in the embodiment depicted in FIG. 2, the third-party server 118 may be disposed between the controller 102 and the user devices 106, 108, 110 or distribution outlet devices 112, 114, 116.

The primary difference between the two alternative embodiments depicted in FIGS. 1 and 2 is that the embodiment of FIG. 2 includes the third-party server 118 which may be operable by an entity both distinct and physically remote from the entity operating the controller 102. The third-party server 118 may perform the methods of the present invention by sending/receiving signals to/from the controller 102 to be relayed to/from the user devices 106, 108, 110 and/or distribution outlet devices 112, 114, 116. For example, a broker dealer/clearing house firm may operate a third-party server 118 that communicates with a distribution outlet server (functioning as a controller 102) to receive a transaction request from a client's personal computer (functioning as a user device 106). In some embodiments such as those depicted in FIG. 1, the functions of the third-party server 118 may be consolidated into the controller 102.

An additional difference between these two example embodiments relates to the physical topology of the systems 100, 100′. In both embodiments, each node may securely communicate with every other node in the systems 100, 100′ via, for example, a virtual private network (VPN). Thus, all nodes may be logically connected. However, the embodiment depicted in FIG. 2 allows the controller 102 and/or the third-party server 118 to serve as a single gateway between the nodes that will typically be operated by the owners of the user devices 106, 108, 110 (and the owner's family, employees, and/or customers) and the other nodes in the system 100′, i.e. nodes that may be operated by merchants or others. Thus, in the case that either or both WAN A 120 and WAN B 122 are private networks (e.g. a private LAN and/or WAN not part of the Internet), the user devices 106, 108, 110 and the distribution outlet devices 112, 114, 116 are physically segmented and can easily be physically separated for security, control, and/or other reasons. In some embodiments, WAN A 120 may be implemented using the Internet while WAN B 122 remains a private LAN or WAN. In some embodiments, WAN B 122 may be implemented using the Internet while WAN A 120 remains a private LAN or WAN. If both WAN A 120 and WAN B 122 are implemented using the Internet, the system 100′ is effectively the same as system 100 with an added direct connection from the controller 102 to a third-party server 118.

In some embodiments, the distribution outlet devices 112, 114, 116 may each be controlled by different merchants or distribution outlets. The controller 102 may be operated by an entity that uses the present invention, for example, to deliver potential clients to distribution outlets, provide distribution outlets with information and/or application services, provide clients of distribution outlets with portfolio information or other services. If there is a third-party server 118, it may be operated by an unrelated entity that merely permits the operators of the controller 102 to have access to different services such as information brokers, financial brokers, financial networks, payment services, transaction services, and the like.

Thus, in such an example embodiment, the system of the present invention may involve merchants (operating distribution outlet devices 112, 114, 116), an applications service provider (operating the controller 102), a financial clearing house firm (operating third-party servers 118), and clients (operating user devices 106, 108, 110). In alternative embodiments, a distribution outlet may operate a combined controller/DO device directly and the system may only involve an distribution outlet.

In both embodiments pictured in FIGS. 1 and 2, communication between the controller 102 and the distribution outlet devices 112, 114, 116, the user devices 106, 108, 110, and/or the third-party server 118, may be direct and/or via a network such as the Internet 104.

Referring to both FIGS. 1 and 2, each of the controller 102, the third-party server 118, the distribution outlet devices 112, 114, 116, and the user devices 106, 108, 110 may comprise computers, such as those based on the Intel® Pentium® processor, that are adapted to communicate with each other. Any number of third-party servers 118, distribution outlet devices 112, 114, 116, and/or user devices 106, 108, 110 may be in communication with the controller 102. In addition, the user devices 106, 108, 110 may be in one or two-way communication with the distribution outlet devices 112, 114, 116. The controller 102, the third-party server 118, the distribution outlet devices 112, 114, 116, and the user devices 106, 108, 110 may each be physically proximate to each other or geographically remote from each other. The controller 102, the third-party server 118, the distribution outlet devices 112, 114, 116, and the user devices 106, 108, 110 may each include input devices (not pictured) and output devices (not pictured).

As indicated above, communication between the controller 102, the third-party server 118, the distribution outlet devices 112, 114, 116, and the user devices 106, 108, 110 may be direct or indirect, such as over an Internet Protocol (IP) network such as the Internet 104, an intranet, or an extranet through a web site maintained by the controller 102 (and/or the third-party server 118) on a remote server or over an on-line data network including commercial on-line service providers, bulletin board systems, routers, gateways, and the like. In yet other embodiments, the devices may communicate with the controller 102 over local area networks including Ethernet, Token Ring, and the like, radio frequency communications, infrared communications, microwave communications, cable television systems, satellite links, Wide Area Networks (WAN), Asynchronous Transfer Mode (ATM) networks, Public Switched Telephone Network (PSTN), other wireless networks, and the like.

Those skilled in the art will understand that devices in communication with each other need not be continually transmitting to each other. On the contrary, such devices need only transmit to each other as necessary, and may actually refrain from exchanging data most of the time. For example, a device in communication with another device via the Internet 104 may not transmit data to the other device for weeks at a time.

The controller 102 (and/or the third-party server 118) may function as a “web server” that presents and/or generates web pages which are documents stored on Internet-connected computers accessible via the World Wide Web using protocols such as, e.g., the hyper-text transfer protocol (“HTTP”). Such documents typically include one or more hyper-text markup language (“HTML”) files, associated graphics, and script files. A web server allows communication with the controller 102 in a manner known in the art. The distribution outlet devices 112, 114, 116 and the user devices 106, 108, 110 may use a web browser, such as NAVIGATOR® published by NETSCAPE® for accessing HTML forms generated or maintained by or on behalf of the controller 102 and/or the third-party server 118.

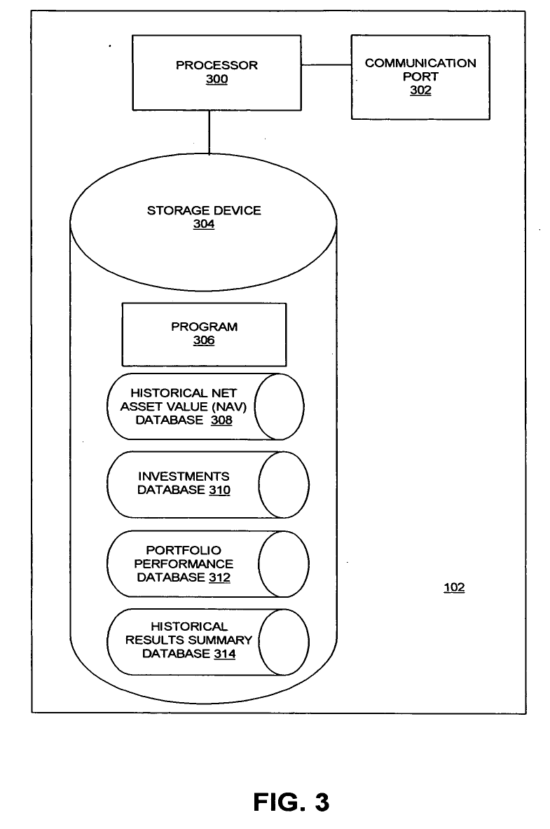

As indicated above, any or all of the controller 102, the third-party server 118, the distribution outlet devices 112, 114, 116 and the user devices 106, 108, 110 may include, e.g., processor based cash registers, telephones, interactive voice response (IVR) systems such as the ML400-IVR designed by MISSING LINK INTERACTIVE VOICE RESPONSE SYSTEMS, cellular/wireless phones, vending machines, pagers, personal computers, portable types of computers, such as a laptop computer, a wearable computer, a palm-top computer, a hand-held computer, and/or a Personal Digital Assistant (“PDA”). Further details of the controller 102, and/or the third-party server 118, are provided below with respect to FIG. 3.

As indicated above, in some embodiments of the invention the controller 102 (and/or the third-party server 118) may include distribution outlet devices 112, 114, 116, and/or user devices 106, 108, 110. Further, the controller 102 may communicate with advisors directly instead of through the distribution outlet devices 112, 114, 116. Likewise, the controller 102 may communicate with clients directly instead of through the user devices 106, 108, 110. Although not pictured, the controller 102, the third-party server 118, the distribution outlet devices 112, 114, 116, and the user devices 106, 108, 110 may also be in communication with one or more user and/or advisor credit institutions to effect transactions and may do so directly or via a secure financial network such as the Fedwire network maintained by the United States Federal Reserve System, the Automated Clearing House (hereinafter “ACH”) Network, the Clearing House Interbank Payments System (hereinafter “CHIPS”), or the like.

In operation, the distribution outlet devices 112, 114, 116 and/or the user devices 106, 108, 110 may exchange information, for example, about the investments, portfolios, historical net asset value (NAV) data, and the like via the controller 102. In embodiments with a third-party server 118, the distribution outlet devices 112, 114, 116 and/or the user devices 106, 108, 110 may exchange information about the investments, portfolio maintenance, and performance via the third-party server 118. The distribution outlet devices 112, 114, 116 may for example, provide customer information, transaction information, and/or other information to the controller 102 (and/or the third-party server 118). The user devices 106, 108, 110 may provide client account information, registration information, transaction requests, and/or other information to the controller 102 (and/or the third-party server 118). The controller 102 (and/or the third-party server 118) may provide information about investment performance, client account information, product presentation information, and/or application software to the distribution outlet devices 112, 114, 116 and also send qualified clients to the DO devices 112, 114, 116 for registration and service.

### C. DEVICES

FIG. 3 is a block diagram illustrating details of an example of the controller 102 of FIG. 1 (and/or the third-party server 118 of FIG. 2). The controller 102 is operative to manage the system and execute the methods of the present invention. The controller 102 may be implemented as one or more system controllers, one or more dedicated hardware circuits, one or more appropriately programmed general purpose computers, or any other similar electronic, mechanical, electromechanical, and/or human operated device. For example, in FIG. 2, the controller 102 is depicted as coupled to a third-party server 118. In the embodiment of FIG. 2, these two servers may provide the same functions as the controller 102 alone in the embodiment of FIG. 1.

The controller 102 (and/or the third-party server 118) may include a processor 300, such as one or more Intel® Pentium® processors. The processor 300 may include or be coupled to one or more clocks or timers (not pictured), which may be useful for determining information relating to, for example, whether a mutual fund transaction deadline has occurred, and one or more communication ports 302 through which the processor 300 communicates with other devices such as the distribution outlet devices 112, 114, 116, the user devices 106, 108, 110 and/or the third-party server 118. The processor 300 is also in communication with a data storage device 304. The data storage device 304 may include any appropriate combination of magnetic, optical and/or semiconductor memory, and may include, for example, additional processors, communication ports, Random Access Memory (“RAM”), Read-Only Memory (“ROM”), a compact or DVD disc and/or a hard disk. The processor 300 and the storage device 304 may each be, for example: (i) located entirely within a single computer or other computing device; or (ii) connected to each other by a remote communication medium, such as a serial port cable, a LAN, a telephone line, radio frequency transceiver, a fiber optic connection or the like. In some embodiments for example, the controller 102 may comprise one or more computers (or processors 300) that are connected to a remote server computer operative to maintain databases, where the data storage device 304 is comprised of the combination of the remote server computer and the associated databases.

The data storage device 304 may store a program 306 for controlling the processor 300. The processor 300 may perform instructions of the program 306, and thereby operate in accordance with the present invention, and particularly in accordance with the methods described in detail herein. The present invention may be embodied as a computer program developed using an object oriented language that allows the modeling of complex systems with modular objects to create abstractions that are representative of real world, physical objects and their interrelationships. However, it would be understood by one of ordinary skill in the art that the invention as described herein can be implemented in many different ways using a wide range of programming techniques as well as general purpose hardware systems or dedicated controllers. The program 306 may be stored in a compressed, uncompiled and/or encrypted format. The program 306 furthermore may include program elements that may be generally useful, such as an operating system, a database management system and “device drivers” for allowing the processor 300 to interface with computer peripheral devices. Appropriate general purpose program elements are known to those skilled in the art, and need not be described in detail herein.

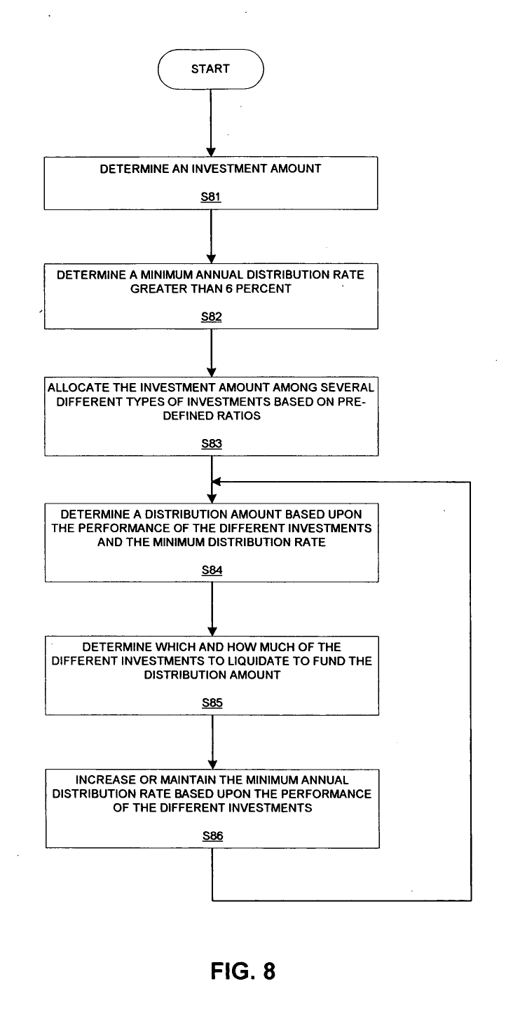

Further, the program 306 is operative to execute a number of invention-specific modules or subroutines including but not limited to one or more routines to allow an DO to describe an investment method via a user device 106, 108, 110 and/or a DO device 112, 114, 116; one or more routines to receive information about an investment opportunity and/or client; one or more routines to receive transaction information or client information from an advisor or a client; one or more routines to determine withdrawal payments for clients; one or more routines to compute a withdrawal rate, a distribution amount, and a source of funding; one or more routines to generate investment performance reports and status information; one or more routines to present fund information and customized client presentations to advisors; one or more routines to compensate advisors for services provided to clients; one or more routines to facilitate and control communications between distribution outlet devices 112, 114, 116, user devices 106, 108, 110, the controller 102, and/or a third party server 118; and one or more routines to control databases or software objects that track information regarding clients, advisors, third parties, user devices 106, 108, 110, qualified investments, payments, actual investments, and fulfillment. Examples of some of these routines and their operation are described in detail below in conjunction with the flowcharts depicted in FIGS. 8 through 19.

According to some embodiments of the present invention, the instructions of the program 306 may be read into a main memory (not pictured) of the processor 300 from another computer-readable medium, such from a ROM to a RAM. Execution of sequences of the instructions in the program 306 causes the processor 300 to perform the process steps described herein. In alternative embodiments, hard-wired circuitry or integrated circuits may be used in place of, or in combination with, software instructions for implementation of the processes of the present invention. In some embodiments, the methods of the present invention may be performed entirely by one or more humans communicating and/or interacting. Thus, embodiments of the present invention are not limited to any specific combination of hardware, firmware, and/or software.

In addition to the program 306, the storage device 304 is also operative to store (i) a historical net asset value (NAV) database 308, (ii) an investments database 310, (iii) a portfolio performance database 312, and (iv) a results summary database 314. The databases 308, 310, 312, 314 are described in detail below and example structures are depicted with sample entries in the accompanying figures. As will be understood by those skilled in the art, the schematic illustrations and accompanying descriptions of the sample databases presented herein are exemplary arrangements for stored representations of information. Any number of other arrangements may be employed besides those suggested by the tables shown. For example, even though four separate databases are illustrated, the invention could be practiced effectively using one, two, three, five, six, or more functionally equivalent databases. Similarly, the illustrated entries of the databases represent exemplary information only; those skilled in the art will understand that the number and content of the entries can be different from those illustrated herein. Further, despite the depiction of the databases as tables, an object based model could be used to store and manipulate the data types of the present invention and likewise, object methods or behaviors can be used to implement the processes of the present invention. These processes are described below in detail with respect to FIGS. 8 through 19.

Although not pictured in detail, user devices 106, 108, 110 and distribution outlet devices 112, 114, 116 according to the present invention may each include a processor coupled to a communications port, a data storage device that stores an institution or advisor program, and an I/O device. An distribution outlet program may include one or more routines to facilitate and control communications and interaction with the controller 102 as well as an interface to facilitate communications and interaction with an institution or the institution's computing system. Likewise, a user or client program may include one or more routines to facilitate and control communications and interaction with the controller 102 as well as an interface to facilitate communications and interaction with an advisor or an advisor's computing systems. As indicated above, user devices 106, 108, 110 and distribution outlet devices 112, 114, 116 may be implemented by any number of devices such as, for example, a processor based cash register, a telephone, an IVR system, a cellular/wireless phone, a vending machine, a pager, a personal computer, a portable computer such as a laptop, a wearable computer, a palm-top computer, a hand-held computer, and/or a PDA.

### D. DATABASE

As indicated above, it should be noted that although the example embodiment of FIG. 3 is illustrated to include four particular databases stored in storage device 304, other database arrangements may be used which would still be in keeping with the spirit and scope of the present invention. In other words, the present invention could be implemented using any number of different database files or data structures, as opposed to the four depicted in FIG. 3. Further, the individual database files could be stored on different servers (e.g. located on different storage devices in different geographic locations, such as on a third-party server 118). Likewise, the program 306 could also be located remotely from the storage device 304 and/or on another server. As indicated above, the program 306 includes instructions for retrieving, manipulating, and storing data in the databases 308, 310, 312, 314 as necessary to perform the methods of the invention as described below.

1. Historical Net Asset Value Database

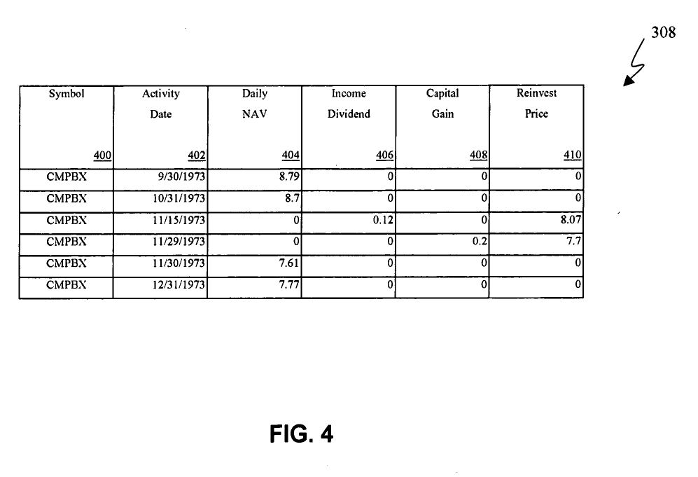

Turning to FIG. 4, a tabular representation of an embodiment of a historical NAV database 308 according to some embodiments of the present invention is illustrated. This particular tabular representation of a historical NAV database 308 includes six sample records or entries which each include information regarding a particular event effecting the value of a mutual fund. In some embodiments of the invention, a historical NAV database 308 is used to report and track information about particular mutual funds' value history. Thus, for example, a historical NAV database 308 may be useful for determining the historical value of an investment between any two dates. While the particular example historical NAV database 308 depicted in FIG. 4 includes only six sample entries, those skilled in the art will understand that such a database 308 may include any number of entries.

The particular tabular representation of a historical NAV database 308 depicted in FIG. 4 defines a number of fields for each of the entries or records. The fields may include: (i) a symbol field 400 that may store a representation of an investment ticker symbol that uniquely identifies the investment; (ii) an activity date field 402 that may store a representation of a date upon which the event represented by the given entry occurred; (iii) a daily NAV field 404 that may store a representation of a net asset value of the investment on the date indicated by the value in the activity date field 402 or, in some entries, the value in the daily NAV field 404 may indicate that an income dividend or capital gain event occurred; (iv) an income dividend field 406 that may store a representation of an amount of income per share was earned in the form of a dividend on the activity date; (v) a capital gain field 408 that may store a representation of an amount of income per share was realized in the form of a capital gain on the activity date; and (vi) a reinvestment price field 410 that may store a representation of the price per share at which value received via an income dividend or a capital gain may be reinvested back into the investment at the time of the activity date.

The particular tabular representation of a historical NAV database 308 depicted in FIG. 4 includes example data to further illustrate the present invention particularly with regard to using a historical NAV database 308 according to the invention. All of the sample entries happen to be associated with the investment “CMPBX” however, the dates span from Sep. 30, 1973 to Dec. 21, 1973. On Sep. 30, 1973, Oct. 31, 1973, Nov. 30, 1973, and Dec. 31, 1973, data reflecting the then current value of the respective investment is stored. In contrast, on Nov. 15, 1973 and Nov. 29, 1973 income dividend and capital gain events occurred, respectively. The example data thus indicates that the $0.12 per share received via the income dividend could have been reinvested in CMPBX by purchasing shares at the reinvestment price of $8.07 per share on Nov. 15, 1973. Likewise, the example data reflects that the $0.20 per share received via the capital gain could have been reinvested in CMPBX by purchasing shares at the reinvestment price of $7.70 per share on Nov. 29, 1973. Thus, assuming complete and accurate data, a historical NAV database 308 such as depicted in FIG. 4 may be used in the methods and systems of the present invention to compute historical performance of an investment over any desired date range. Further details regarding NAV data and other financial information may be found in a text book entitled “Investments, An Introduction” by Herbert B. Mayo, sixth ed., Pub. The Dryden Press, 2000, which is hereby incorporated herein for all purposes.

2. Investments Database

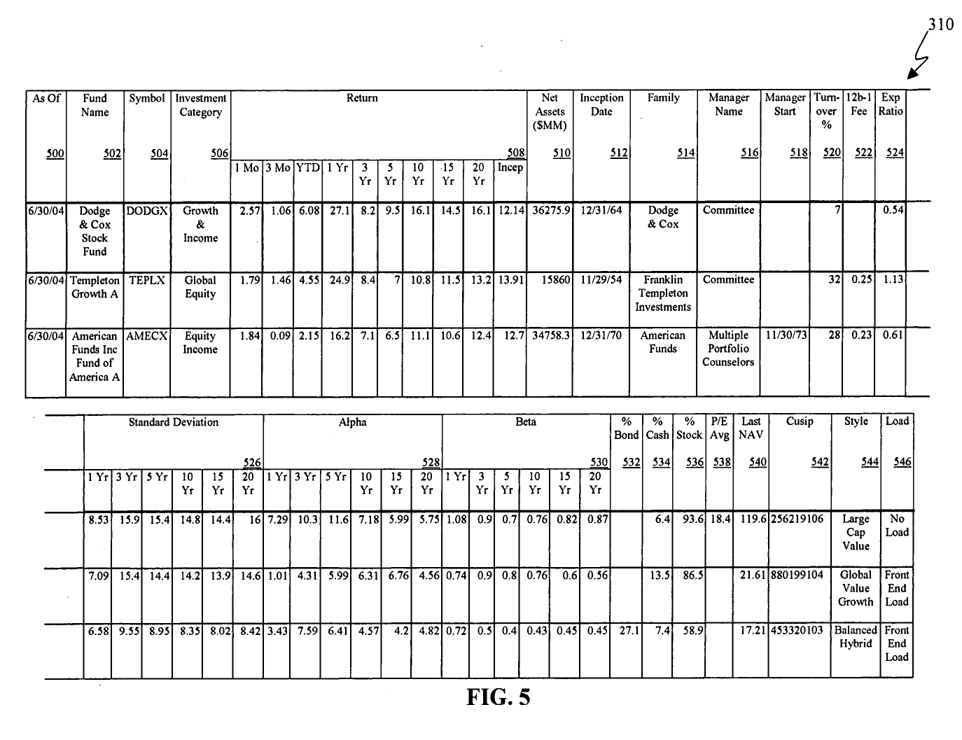

Turning to FIG. 5, a tabular representation of an embodiment of a investments database 310 according to some embodiments of the present invention is illustrated. This particular tabular representation of a investments database 310 includes three sample records or entries which each include information regarding a particular investment. In some embodiments of the invention, an investment database 310 is used to store and retrieve information about particular mutual funds' performance and other data. Those skilled in the art will understand that such a investments database 310 may include any number of entries.

The particular tabular representation of a investments database 310 depicted in FIG. 5 defines a number of fields for each of the entries or records. The fields may include: (i) an As Of field 500 which may store a representation of a date indicating the point in time at which the data in the entry was current; (ii) a fund name field 502 which may store a representation of the name of the investment whose information is described by the entry; (iii) a symbol field 504 that may store a representation of an investment ticker symbol that uniquely identifies the investment and may facilitate cross reference back to the historical NAV database 308; (iv) an investment category field 506 that may store a representation of the fund's chosen investment style; (v) a return field 508 that may store representations of the returns the investment has yielded over various different time periods (e.g., one month, three months, year to date, one year, three years, five years, ten years, fifteen years, twenty years, since inception of the fund, etc.); (vi) a net assets field 510 that may store a representation of the value of the total assets minus the liabilities of the fund; (vii) an inception date field 512 that may store a representation of the date upon which the fund began investing; (viii) a family field 514 that may store a representation of a group of funds to which the fund is related, possibly based on the fund management or other factor; (ix) a manager name field 516 that may store a representation of the name of the manager(s) of the fund and/or an indication of whether the fund is managed by a committee; (x) a manager start field 518 that may store a representation of the date on which the manager began managing the fund; (xi) a turnover percentage field 520 that may store a representation indicating the frequency with which the individual investments (positions) of the fund are changed; (xii) a 12b-1 fee field 522 that may store a representation of a distribution fee paid to advisors, managers and/or institutions charged by the fund to cover promotion, distributions, marketing expenses, and sometimes commissions to brokers associated with the fund; (xiii) an expense ratio field 524 that may store a representation of the operating costs, including management fees, expressed as a percentage of the fund's average net assets for a given time period; (xiv) a standard deviation field 526 that may store a representation of a statistical measure of the historical volatility of a mutual fund measured over various different time periods (e.g., one year, three years, five years, ten years, fifteen years, twenty years, since inception of the fund, etc.); (xv) an alpha field 528 that may store a representation of a coefficient measuring the risk-adjusted performance, considering the risk due to the specific security, rather than the overall market, measured over various different time periods (e.g., one year, three years, five years, ten years, fifteen years, twenty years, since inception of the fund, etc.); (xvi) a beta field 530 that may store a representation of a quantitative measure of the volatility of a given stock, mutual fund, or portfolio, relative to the overall market, usually the S&P 500, as measured over various different time periods (e.g., one year, three years, five years, ten years, fifteen years, twenty years, since inception of the fund, etc.); (xvii) a percentage bond field 532 that may store a representation of the percentage of the fund's assets in bonds on the As Of date 500; (xviii) a percentage cash field 534 that may store a representation of the fund's assets in cash on the As Of date 500; (xix) a percentage stock field 536 that may store a representation of the fund's assets in equities on the As Of date 500; (xx) a price earnings ratio average field 538 that may store a representation of a fund's average market capitalization divided by its after-tax earnings over a 12-month period; (xxi) a last NAV field 540 that may store a representation of the fund's net asset value per share on the As Of date 500; (xxii) a CUSIP field 542 that may store a representation of a nine-character identification number that uniquely identifies the investment as assigned by the Committee on Uniform Securities Identification Procedures; (xxiii) a style field 544 that may store a representation of a description of an investment style category of the fund according to the present invention; and (xxiv) a load field 546 that may store a representation indicating the type of load associated with the investment. The particular tabular representation of an investment database 310 depicted in FIG. 5 includes example data to further illustrate the present invention particularly with regard to using an investment database 310 according to the invention.

3. Portfolio Performance Database

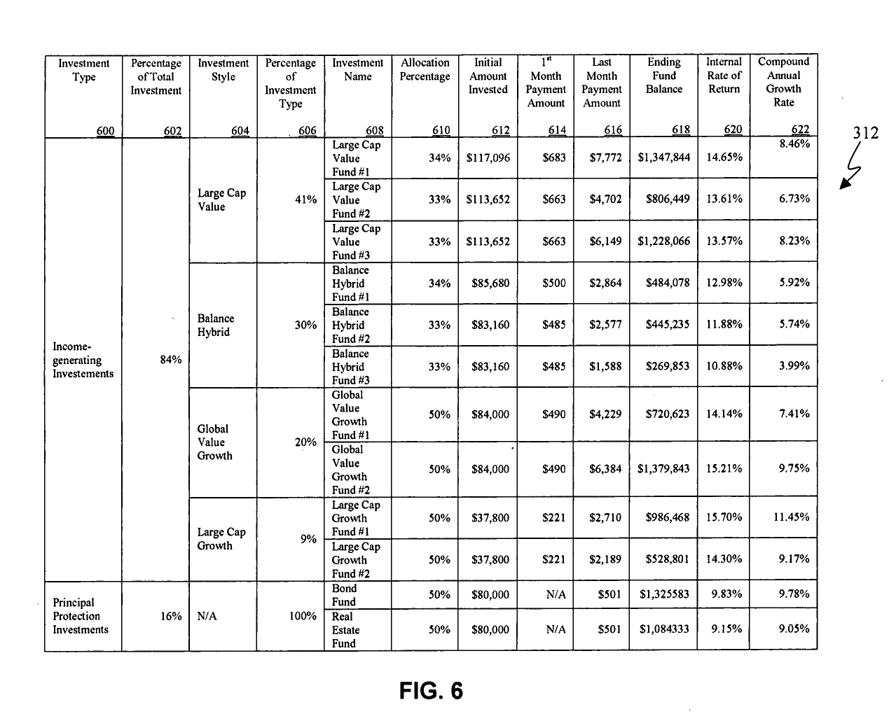

Turning to FIG. 6, a tabular representation of an embodiment of a portfolio performance database 312 according to some embodiments of the present invention is illustrated. This particular tabular representation of a portfolio performance database 312 includes twelve sample records or entries which each include information regarding a particular individual investment in a portfolio in accordance with the present invention. In some embodiments of the invention, a portfolio performance database 312 is used to report information about a portfolio's performance broken down to the level of the particular investments' performance. Those skilled in the art will understand that such a portfolio performance database 312 may include any number of entries practicable within the context of the present invention.

The particular tabular representation of portfolio performance database 312 depicted in FIG. 6 defines a number of fields for each of the entries or records. The fields may include: (i) an investment type field 600 that may store a representation indicating if the investment is either an income-generating investment or a principal protection investment; (ii) a percentage of total investment field 602 that may store a representation of the percentage allocation of the entire amount invested between the income-generating investments and the principal protection investments; (iii) an investment style field 604 that may store a representation of the investment style category to which the individual investment belongs (e.g., large cap value, balanced hybrid, global value growth, large cap growth, bond/fixed income, etc.); (iv) a percentage of investment type field 606 that may store a representation of the allocation of the amount invested among the income generating investments; (v) an investment name field 608 that may store a representation of the name of the fund or investment; (vi) an allocation percentage field 610 that may store a representation of the allocation within each investment style category; (vii) an initial amount invested field 612 that may store a representation of the value of the initial amounts distributed to each investment style category; (viii) a 1^{st} month payment amount field 614 that may store a representation of the value of the first period's distribution amount; (ix) a last month payment amount field 616 that may store a representation of the value of the final period's distribution amount; (x) an ending fund balance field 618 that may store a representation of the total value of each individual investment at the end of the evaluated period; (xi) an internal rate of return field 620 that may store a representation of the percentage return on each individual investment realized by use of the present invention; and (xii) a compound annual growth rate field 622 that may store a representation of year over year growth rate applied to an investment over a multiple-year period (i.e., CAGR=(current value/base value)ˆ(1/# of years)-1).

The particular tabular representation of a portfolio performance database 312 depicted in FIG. 6 includes example data to further illustrate the present invention particularly with regard to using a portfolio performance database 312 according to the invention. The results displayed are based upon one million dollars initially invested in early 1973, the allocation percentages shown, using a seven percent initial withdrawal rate, and an eight percent cap (i.e., Distribution Type B).

4. Results Summary Database

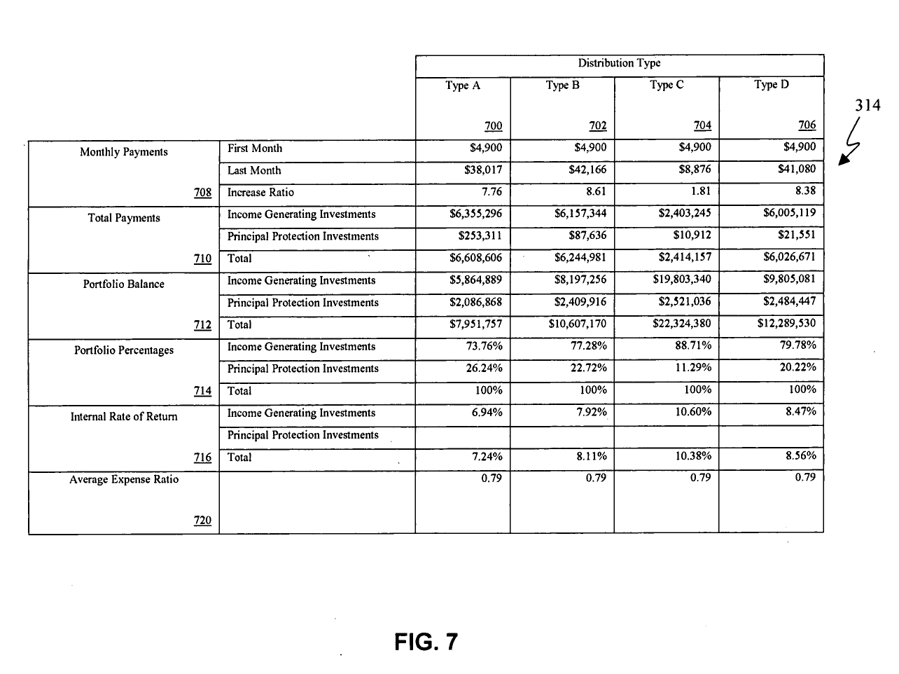

Turning to FIG. 7, a tabular representation of an embodiment of a results summary database 314 according to some embodiments of the present invention is illustrated. This particular tabular representation of a results summary database 314 includes four sample records or entries which each include information regarding the summary results for a particular distribution type, A through D 700, 702, 704, 706. In some embodiments of the invention, a results summary database 314 is used to report information to allow comparison of different distribution types using the same investment allocations. Those skilled in the art will understand that such a historical results summary database 314 may include any number of entries practicable within the context of the present invention.

The particular tabular representation of a results summary database 314 depicted in FIG. 7 defines a number of fields for each of the entries or records. The fields may include: (i) a monthly payments field 708 that may store a representation of distribution amounts for the first and last months as well as an increase ratio for each of the distribution methods; (ii) a total payments field 710 that may store a representation of the total amount funded by the income generating investments and the principal protection investments as well as the total distribution payments for both types, for each of the distribution methods; (iii) a portfolio balance field 712 that may store a representation of the end balance from the income generating investments and the principal protection investments as well as the total balance for both types for each of the distribution methods; (iv) a portfolio percentages field 714 that may store a representation of the allocation of investments between the income generating investments and the principal protection investments for each of the distribution methods; (v) an internal rate of return field 716 that may store a representation of the return on investment realized by the income generating investments for each of the distribution methods; and (vi) an average expense ratio field 720 that may store a representation of the average expense ratio for each of the distribution methods. The particular tabular representation of a results summary database 314 depicted in FIG. 7 includes example data to further illustrate the present invention particularly with regard to using a results summary database 314 according to the invention. This sample data is discussed in more detail below with regard to Example 2.

### E. METHODS

The system discussed above, including the hardware components and the databases, are useful to perform the methods of the invention. However, it should be understood that not all of the above described components and databases are necessary to perform any of the present invention's methods. In fact, in some embodiments, none of the above described system is required to practice the invention's methods. The system described above is an example of a system that would be useful in practicing the invention's methods. For example, the NAV database 308 described above is useful for tracking the value of mutual funds and information about them, but it is not absolutely necessary to have such a database in order to perform the methods of the invention. In other words, the methods described below may be practiced using conventional reports and other information about the funds in conjunction with stock value information.

Referring to FIGS. 8 through 19, flow charts are depicted that represents some embodiments of the present invention that may be performed by the controller 102. (FIGS. 1 and 2), an external third party, and/or an integrated third party entity/device such as a third-party server 118. It must be understood that the particular arrangement of elements in the flow charts of FIGS. 8 through 19, as well as the order of example steps of various methods discussed herein, is not meant to imply a fixed order, sequence, and/or timing to the steps; embodiments of the present invention can be practiced in any order, sequence, and/or timing that is practicable.

In general terms, the methods of the present invention may be summarized as follows. In an initial step, a total investment amount is determined. In some embodiments, the amount chosen may be based upon many different factors including the size of a desired income stream, life expectancy considerations, a target end balance or remainder amount, etc.

In a next step, the investment amount is allocated between income generating type investments and principal protection type investments. In some embodiments, the allocation may be done based on predefined ratios. In some embodiments, eighty-four percent of the investment amount may be allocated to income generating investments while sixteen percent may be allocated to principal protection investments. As their names imply, the income generating investments and the principal protection investments are intended to serve two distinct but complementary functions. The income generating investments may be thought of as offensive, growth oriented investments, selected to provide an income stream while simultaneously enhancing the principal. The principal protection investments may be thought of as defensive, safety oriented investments, selected to provide support for the income generating investments when the market is down by providing an alternative source of distribution funds that stand-by for whenever they are needed.

Within the income generating type investments, the investment amount may be allocated among different “styles” of investments based on predefined ratios in a next step. In some embodiments, ˜31.44% (i.e., 41% of the 84%) of the investment amount may be allocated to large cap value style investments, ˜25.20% (i.e., 30% of the 84%) of the investment amount may be allocated to balanced hybrid style investments, ˜16.80% (i.e., 20% of the 84%) of the investment amount may be allocated to global value growth style investments, and ˜7.56% (i.e., 9% of the 84%) of the investment amount may be allocated to large cap growth style investments. In some embodiments, different styles and different ratios may be used.

In a next step, particular mutual funds and/or other investments within each style may be chosen from among a select group of investments. To be included in the select group of investments, a mutual fund must meet or exceed specific criteria. In some embodiments, the criteria may include a track record in excess of a predefined number of years, manager continuity of a predefined number of years, a downside deviation less than a predefined value, a Sortino ratio greater than a predefined value, an Omega excess greater than a predefined value, a downside risk adjusted return greater than a predefined value, etc. These predefined values may selected based upon comparison of all available investment opportunities. In some embodiments, an investments database 310 may be used for such a purpose. The predefined values may be selected using, for example, values that are more than two standard deviations above a mean value. In some embodiments, predefined values may be selected by determining the values of investments in a top performance percentile. In some embodiments, more subjective data may be used to determine whether a particular investment meets the appropriate standard, particularly in the absence of available objective data.

In alternative and/or additional embodiments, the select group of investments may be determined based up a multi-dimensional filtering process using a variable weighting system that allows an investor (or advisor) to give certain parameters and/or dimensions higher priority than others. For example, a filter may be configured to allow sorting of investments based on a weighting such as X % of dimension 1, Y % of dimension 2, and Z % of dimension 3 where X %+Y %+Z %=100%. Dimension 1 may include three, five and ten year returns. Dimension 2 may include a set of performance ratings such as return ranking, trailing return ranking, standard deviation, beta, downside deviation, upside potential, and omega excess. Dimension 3 may include a set of miscellaneous factors such as net asset size, inception date, a scaled score based on subjective factors. Within each dimension, the parameters may be weighted to further reflect the priorities of an individual investor (or advisor). Thus, for example, the X % of dimension 1 may be comprised of Q % of three year return, R % of five year return, and S % of ten year return (i.e., Q %+R %+S %=100% of X %). Similarly, dimension 2 and 3 may have different weights assigned to each parameter within the respective dimension. Using a spreadsheet, for example, an investor may sort all of the investments for which data is available based upon the weights of each dimension and within the dimensions, based upon the weights of each parameter. The investor may then eliminate or filter any investments that do not exceed a particular threshold of his choosing. Alternatively and/or additionally, the investor may use the customized multi-dimensional ranking to simply select the desired number of the highest ranked investments within each investment style category.

In some embodiments, at least one mutual fund is selected within in each of the different investment style categories. Where more than one investment is selected within a style category, allocation percentages may be specified. In some embodiments, allocations among individual investments within a style category may be distributed evenly and in some embodiments, investors may choose to favor particular individual investments over others and distribute the corresponding allocations accordingly. Likewise, at least one investment is identified from among a selection of principal protection type investments. Where more than one investment is selected from among the principal protection type investments, allocation percentages may be specified.

In a next step, a distribution type is selected. In some embodiments, a choice of many different distribution types may be provided. Selection of a distribution type may be influenced by many different factors including the size of a desired income stream, the desired frequency and size of raises in the distribution amounts, life expectancy considerations, a target end balance or remainder amount, etc.

In some embodiments, a choice of four different distribution types may be provided. In some embodiments of the distribution methods, referred to as Type A herein, monthly distribution amounts may be based on a withdrawal percentage of the value of each of the individual income generating investments determined at the end the year or other period. In some embodiments, the distribution amount may be held constant at the prior year's level for a given income generating investment, even if the value of the investment has declined at the end of a given year.

Note that in any of the distribution embodiments described herein (except Type C), the distribution amount may be held constant for a given investment even if the selected distribution method would otherwise suggest decreasing the withdrawal amount. In some embodiments, the distribution amount may be permitted to be decreased. Also note that distribution amounts may by computed on an annual (or other periodic) basis and then paid out on a monthly (or other periodic) basis. Also note that the income generating investments may be evaluated individually to determine how much of the total distribution each contributes. In other words, each income generating investment stands on its own and is not supported in making distributions by other income generating investments. As indicated above and as will be discussed in more detail below, the principal protection type investments are used to make up any shortfall in a distribution of an income generating investment. In some embodiments, the income generating investments may be used to collectively fund a total distribution. In some embodiments, all of the different income generating investments are subject to the same distribution type. In some embodiments, different investments may use different distribution types.

In some embodiments of the distribution methods, referred to as Type B herein, monthly distribution amounts may be based on a withdrawal percentage of the value of each of the individual income generating investments at the end the year, but the amount of a raise from a given investment in years where the value of the investment reaches a new “high-water mark” or all-time high, may be restricted (or capped) to a percentage increase over the prior year's distribution for the investment. This may result in smaller raises than a Type A distribution, but the net effect tends to be that the total amount distributed over time is very similar while the ending balance is substantially increased. The rate of change is “smoothed out” over time such that increases in the distribution amount are delayed and may even happen during years in which the value of the corresponding investment is declining.

In some embodiments of the distribution methods, referred to as Type C herein, monthly distribution amounts may be based on an annual cost of living and/or other adjustment (e.g. an inflation adjustment). An initial withdrawal factor may be used to determine the first year's distribution amount and annual increases may be computed independent of the performance of the income generating investments. In some embodiments, an adjustment percentage may be multiplied by the prior year's distribution amount to determine the raise amount which may be added to the prior year's distribution amount to give the current year's distribution amount. This type of distribution provides a regular, predictable increase year to year that is specified at inception of the investment.

In some embodiments of the distribution methods, referred to as Type D herein, monthly distribution amounts may be based on a withdrawal percentage of the value of each of the individual income generating investments at the end the year but the amount of a raise from a given investment may be limited to a “withdrawal cap” percentage of the prior year's distribution amount. Relative to the Type B distribution, the Type D distribution has an even greater smoothing effect and because more principal remains invested, the ending balance may be substantially larger.

In a next step, once the distribution type has been selected, the investments are purchased and distribution amounts are periodically determined according to the selected distribution type. In each case, once the distribution amount for each income generating investment is determined, in a next step, it is determined how to fund the distribution amount of each income generating investment. In some embodiments, a computed portion of the income generating investment is first liquidated and second, if there is a shortfall between the distribution amount and the amount from the income generating investment, a portion of the principal protection investments sufficient to make up the shortfall are sold.

In the subsections that follow, details regarding the above steps will be discussed in greater detail. Note that not all of these steps are required to perform the methods of the present invention and that additional and/or alternative steps are also discussed below. Also note that the above general steps represent features of only some of the embodiments of the present invention and that they may be combined and/or subdivided in any number of different ways so that the methods include more or less actual steps. For example, in some embodiments many additional steps may be added to update and maintain the databases described above. However, as indicated, it is not necessary to use the above described databases in all embodiments of the invention. In other words, the methods of the present invention may contain any number of steps that are practicable to implement the processes described herein. The methods of the present invention are now discussed in detail.

Referring to FIG. 8, methods of some embodiments of the present invention may include the following steps. In Step S81, an investment amount is determined. In Step S82, a minimum annual distribution rate is determined. In some embodiments, the minimum annual distribution rate may be greater than seven or eight percent of the total amount invested (i.e., greater than approximately six percent of the value of the income generating investments). This feature of the present invention is particularly significant in light of the prior art that teaches that withdrawal amounts of more than four percent consume too much principal to be financially sound or even viable, and are simply not sustainable.

In Step S83, the investment amount is allocated among several different types and/or styles of investments based on predefined ratios. In some embodiments, the different types include at least two different types having contrary investment philosophies. In some embodiments, the ratio is determined based upon historical investment data. In some embodiments, the ratio is determined such that the minimum distribution rate can be maintained for longer than a predefined term if, based upon historical investment data, the investment performs at least equal to the investment's worst historical performance over a term of relevant length. In some embodiments, the predefined term is approximately 30 to 40 years, plus or minus three years. In some embodiments, the ratio is determined such that the minimum distribution rate can be maintained indefinitely if, based upon historical investment data, the plurality of individual investments collectively performs at least equal to the plurality of individual investments' worst historical performance.

In some embodiments, the different types include at least five different types, the investment amount is allocated between the different types based upon a predefined ratio, and one of the types is characterized by an investment philosophy that is contrary to an investment philosophy of the others.

In some embodiments, the five different types include large capitalization value style investments, balanced hybrid style investments, global value growth style investments, large capitalization growth style investments, and bond/fixed-income style investments. Large cap value style investments may include, for example, value-oriented large cap mutual funds investing in mature companies that paid regular, steady dividends. Global value growth style investments may include, for example, “global” equity mutual funds, as contrasted with “international” equity funds. The difference being that global funds invest wherever the managers perceive value in equities including within the United States, while international funds are restricted to investing outside of the United States. Balanced hybrid style investments may include, for example, mutual funds that historically invested approximately one third of their assets in dividend paying stocks, one third in high quality bond instruments, and the final one third split between cash and either stocks or bonds based upon the managers' determination of where emerging opportunity resided. Large cap growth style investments may include, for example, high quality mutual funds that invest in the stock of companies such as Microsoft, Cisco, Intel and other technology companies.

In some embodiments, the investment amount may be allocated between bond/fixed-income style investments and the others types of investments based on a ratio of approximately 4:21. However, in some embodiments, the ratio may be as high as approximately 19:81 or as low as approximately 11:89. In some embodiments, approximately 84% (plus or minus 5%) of the investment amount is allocated among the other types of investments based on predefined percentages including: approximately 41% (plus or minus 3%) allocated to large capitalization value investments, approximately 30% (plus or minus 3%) allocated to balanced hybrid investments, approximately 20% (plus or minus 2%) allocated to global value growth investments, and approximately 9% (plus or minus 2%) allocated to large capitalization growth investments. In some embodiments, the percentages may be determined based upon historical investment data. In some embodiments, the percentages may be determined such that the minimum distribution rate can be maintained for longer than a predefined term if, based upon historical investment data, the investment performs at least equal to the investment's worst historical performance over a term of relevant length. In some embodiments, the predefined term is approximately 30 to 40 years, plus or minus three years. In some embodiments, the ratio is determined such that the minimum distribution rate can be maintained indefinitely if, based upon historical investment data, the plurality of individual investments collectively performs at least equal to the plurality of individual investments' worst historical performance.

In Step S84, a distribution or withdrawal amount is determined based upon the performance of the different investments and the minimum distribution rate. In Step S85, it is determined which and how much of the investments to liquidate to fund the distribution amount. In some embodiments, the distribution amount is paid periodically (e.g., monthly) and the minimum distribution rate is determined periodically (e.g., annually). In Step S86, the minimum annual distribution rate is either increased or maintained at the same level based upon the performance of the different investments and/or other factors. In some embodiments, the distribution amount may be increased by an adjustment amount as the minimum distribution rate changes. In some embodiments, the adjustment amount is limited if the current value and/or the year end value of the investment increases to an amount greater than all prior values of the investment. The process then loops back to Step S84 to determine a new annual distribution amount for the subsequent year.

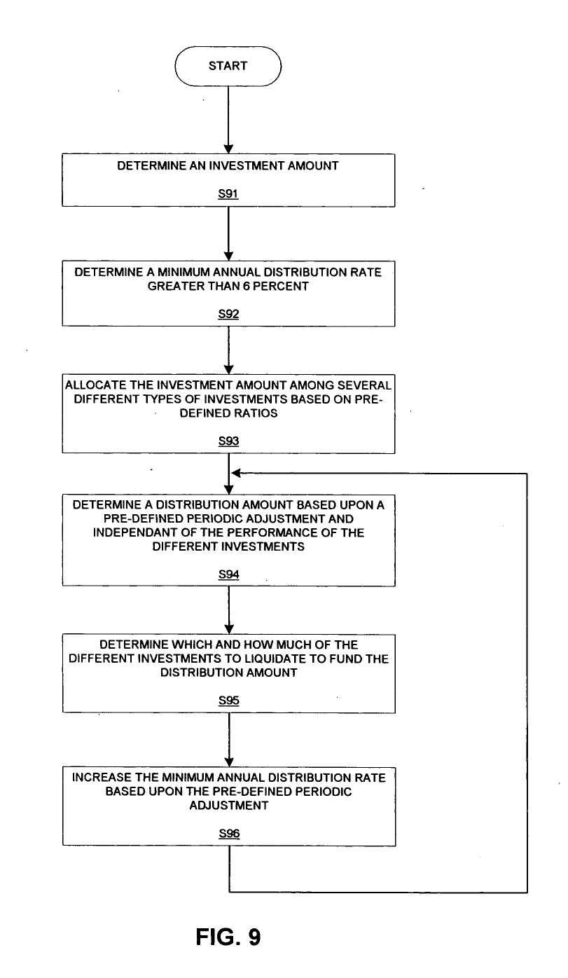

Referring to FIG. 9, methods of some embodiments of the present invention may include the following steps. In Step S91, an investment amount is determined. In Step S92, a minimum annual distribution rate is determined. In some embodiments, the minimum annual distribution rate may be greater than seven or eight percent of the total amount invested (i.e., greater than approximately six percent of the value of the income generating investments). This feature of the present invention is particularly significant in light of the prior art that teaches that withdrawal amounts of more than four percent consume too much principal to be financially sound or even viable, and are simply not sustainable.

In Step S93, the investment amount is allocated among several different types and/or styles of investments based on predefined ratios. In some embodiments, the different types include at least two different types having contrary investment philosophies. In some embodiments, the ratio is determined based upon historical investment data. In some embodiments, the ratio is determined such that the minimum distribution rate can be maintained for longer than a predefined term if, based upon historical investment data,.the investment performs at least equal to the investment's worst historical performance over a term of relevant length. In some embodiments, the predefined term is approximately 30 to 40 years, plus or minus three years. In some embodiments, the ratio is determined such that the minimum distribution rate can be maintained indefinitely if, based upon historical investment data, the plurality of individual investments collectively performs at least equal to the plurality of individual investments' worst historical performance.

In some embodiments, the different types include at least five different types, the investment amount is allocated between the different types based upon a predefined ratio, and one of the types is characterized by an investment philosophy that is contrary to an investment philosophy of the others.

In some embodiments, the five different types include large capitalization value investments, balanced hybrid investments, global value growth investments, large capitalization growth investments, and bond/fixed-income investments. In some embodiments, the investment amount may be allocated between bond/fixed-income style investments and the others types of investments based on a ratio of approximately 4:21. However, in some embodiments, the ratio may be as high as approximately 19:81 or as low as approximately 11:89. In some embodiments, approximately 84% (plus or minus 5%) of the investment amount is allocated among the other types of investments based on predefined percentages including: approximately 41% (plus or minus 3%) allocated to large capitalization value investments, approximately 30% (plus or minus 3%) allocated to balanced hybrid investments, approximately 20% (plus or minus 2%) allocated to global value growth investments, and approximately 9% (plus or minus 2%) allocated to large capitalization growth investments. In some embodiments, the percentages are determined based upon historical investment data. In some embodiments, the percentages are determined such that the minimum distribution rate can be maintained for longer than a predefined term if, based upon historical investment data, the investment performs at least equal to the investment's worst historical performance over a term of relevant length. In some embodiments, the predefined term is approximately 30 to 40 years, plus or minus three years. In some embodiments, the ratio is determined such that the minimum distribution rate can be maintained indefinitely if, based upon historical investment data, the plurality of individual investments collectively performs at least equal to the plurality of individual investment' worst historical performance.

In contrast to the method depicted in FIG. 8, in Step S94, a distribution or withdrawal amount is determined based upon a predefined periodic adjustment amount and independent of the performance of the different investments. In some embodiments, the predefined periodic adjustment is an increasing amount from period to period and/or a dynamically changing amount. In some embodiments, the predefined periodic adjustment is determined based upon cost of living historical information, a cost of living index, an inflation index, a macro economic indicator, client needs, and/or economic news.

In Step S95, it is determined which and how much of the investments to liquidate to fund the distribution amount. In Step S96, the minimum annual distribution rate is increased based upon the predefined periodic adjustment amount. The process then loops back to Step S94 to determine a new annual distribution amount for the subsequent year.

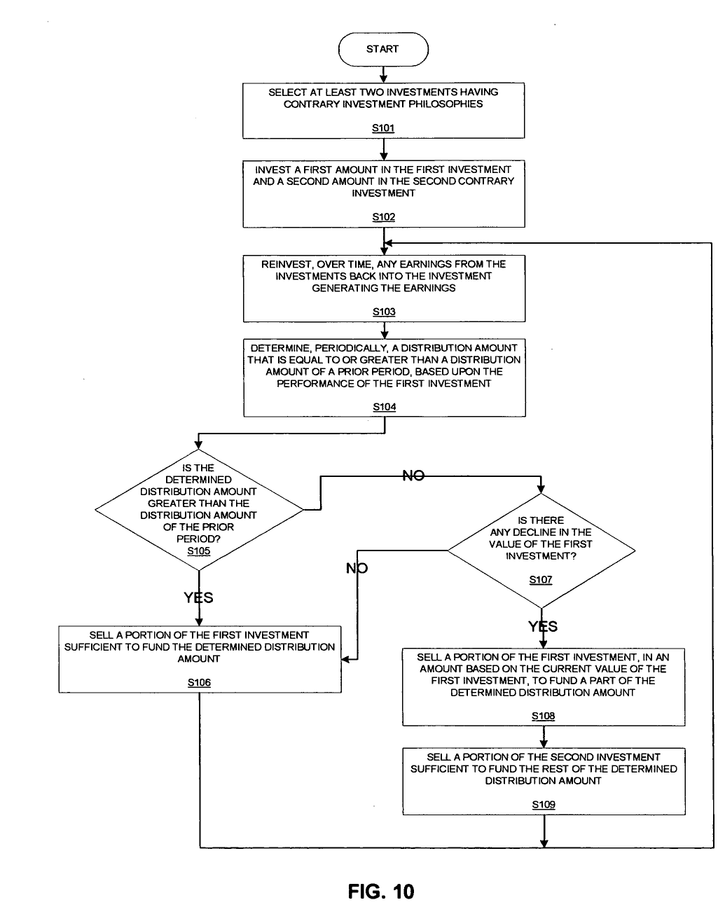

Referring to FIG. 10, methods of some embodiments of the present invention may include the following steps. In Step S101, at least two investments having contrary investment philosophies (e.g., of different types) are selected from among a set of pre-qualified investments. In some embodiments, the investments are selected from a set of investments determined based upon a plurality of historical performance factors including a downside deviation rating, a Sortino ratio, an upside potential ratio, and a downside risk-adjusted return rating. In some embodiments, the set of investments may be limited to, for example, investments with a downside deviation rating smaller than the average downside deviation rating of all investments that have historically performed above a predefined threshold, a Sortino ratio larger than an average Sortino ratio of all investments that have historically performed above a predefined threshold, an upside potential ratio larger than an average upside potential ratio of all investments that have historically performed above a predefined threshold, and/or a downside risk-adjusted return rating larger than an average downside risk-adjusted return rating of all investments that have historically performed above a predefined threshold.

In Step S102, different amounts are invested in the first investment and the second “contrary” investment based on a predefined ratio. In some embodiments, the ratio is determined based upon historical investment performance data (e.g., NAV data). In Step S103, any earnings of the investments (e.g., dividends) are reinvested back into the investment generating the earnings. In Step S104, a distribution amount is determined periodically based upon the performance of the first investment. In Step S105, a decision is made: if the determined distribution amount is greater than the distribution amount of the prior period, then in Step S106, a portion of the first investment sufficient to fund the distribution amount is sold. If however, it is determined in Step S105 that the determined distribution amount is equal to the distribution amount of the prior period, then in Step S107, a second decision is made: if the value of the first investment has not declined, then in Step S106, a portion of the first investment sufficient to fund the distribution amount is sold. If however, it is determined in Step S107 that the value of the first investment has declined, then in Step S108, a portion of the first investment in an amount based on the current value of the first investment, is sold to fund part of the distribution amount. In Step S109, a portion of the second investment sufficient to fund the rest of the distribution amount is sold. After both Steps S106 and S109, flow returns to Step 103 to compute the distributions for subsequent periods.

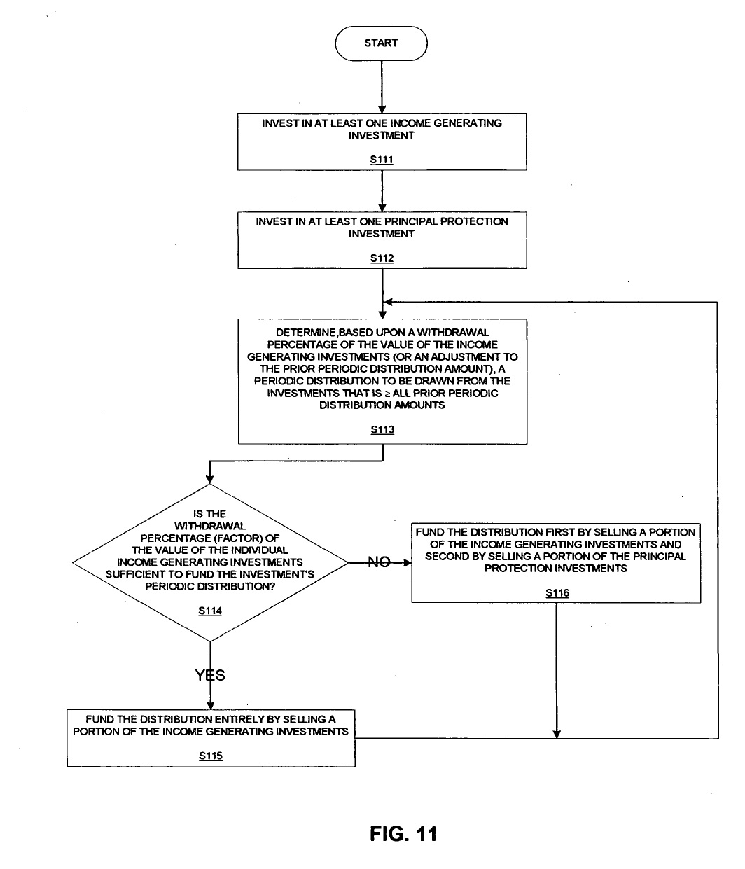

Referring to FIG. 11, methods of some embodiments of the present invention may include the following steps. In Step S111, an investment is made in at least one income generating investment. In Step S112, an investment is made in at least one principal protection investment. In Step S113, a periodic distribution amount greater than or equal to all prior distribution amounts is determined based on a withdrawal percentage of the income generating investment. In Step S114, a decision is made: if the withdrawal percentage of the income generating investment is sufficient to fund the periodic distribution amount, then in Step S115, the distribution is funded entirely by the income generating investment. If however, it is determined in Step S114 that the withdrawal percentage of the income generating investment is not sufficient to fund the periodic distribution amount, then in Step S116, the distribution is funded first by selling a portion of the income generating investment and second by selling a portion of the principal protection investment. After both Steps S115 and S116, flow returns to Step 113 to compute the distributions for subsequent periods.

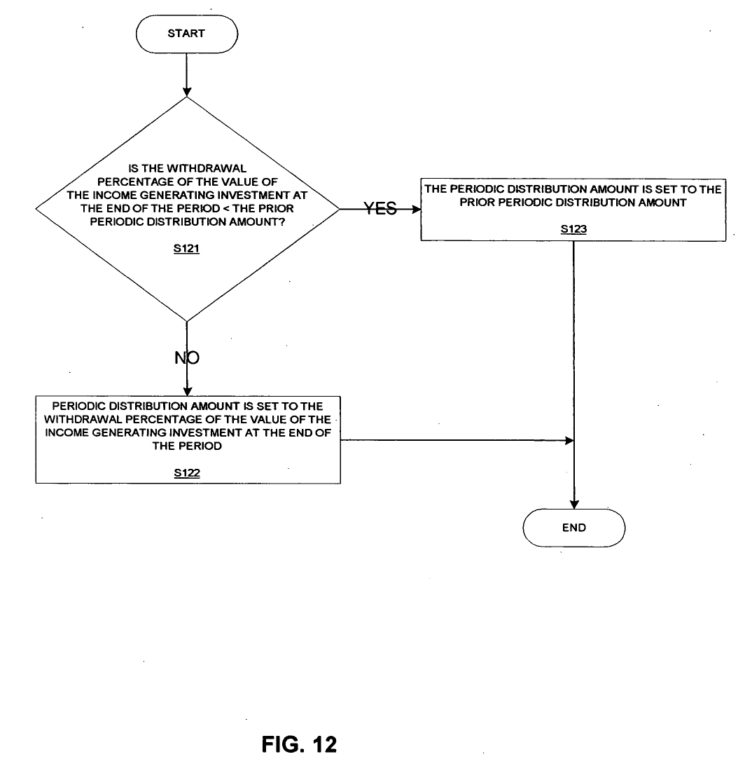

Turning to FIG. 12, the details of a first embodiment of Step S113 are illustrated in a flowchart. FIG. 12 depicts an example of determining a periodic distribution amount using a Type A distribution method. In Step S121, a decision is made: if the withdrawal percentage of the value of the income generating investment at the end of the period is less than the prior periodic distribution amount, then control flows to Step S123. Otherwise, control flows to Step S122. In Step S123, the periodic distribution amount is set to the prior periodic distribution amount and the sub-process ends. In Step S122, the periodic distribution amount is set to the withdrawal percentage of the value of the income generating investment at the end of the period and the sub-process ends.

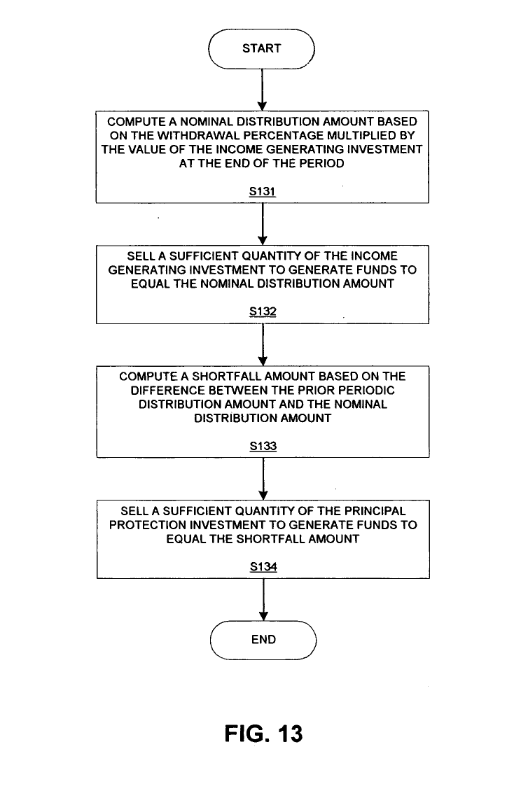

Turning to FIG. 13, the details of a first embodiment of Step S116 are illustrated in a flowchart. FIG. 13 depicts an example of determining how to fund the periodic distribution amount using a Type A distribution method. In Step S131, a nominal distribution amount is computed based on the withdrawal percentage multiplied by the value of the income generating investment at the end of the period. In Step S132, a sufficient quantity of the income generating investment is sold to generate funds to equal the nominal distribution amount. In Step S133, a shortfall amount is computed based on the difference between the prior periodic distribution amount and the nominal distribution amount. In Step S134, a sufficient quantity of the principal protection investment is sold to generate funds to equal the shortfall amount and the sub-process ends.

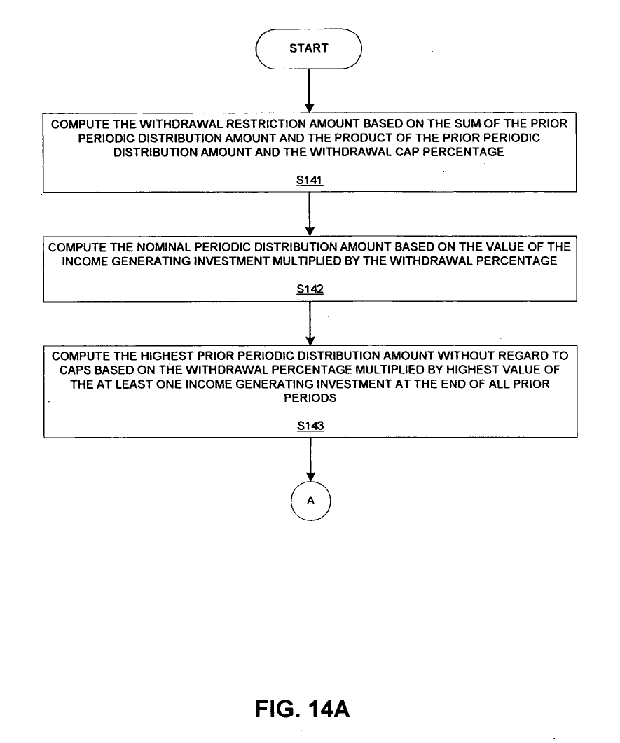

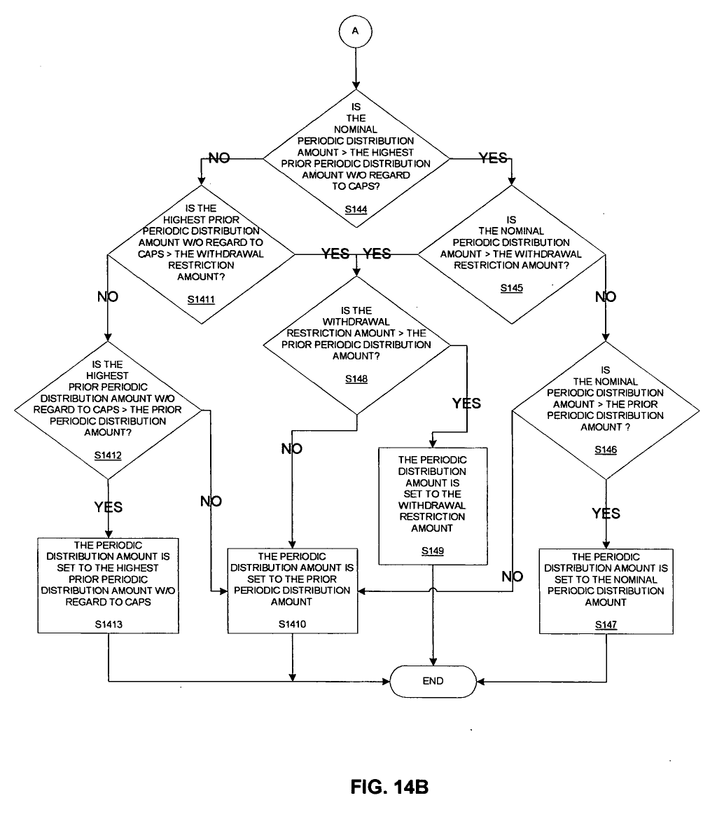

Turning to FIGS. 14A and 14B, the details of a second embodiment of Step S113 are illustrated in a flowchart. FIGS. 14A and 14B depict an example of determining a periodic distribution amount using a Type B distribution method. In Step S141, the withdrawal restriction amount is computed based on the sum of the prior periodic distribution amount and the product of the prior periodic distribution amount and the withdrawal cap percentage. In Step S142, the nominal periodic distribution amount is computed based on the value of the income generating investment multiplied by the withdrawal percentage. In Step S143, the highest prior periodic distribution amount without regard to caps is computed based on the withdrawal percentage multiplied by highest value of the at least one income generating investment at the end of all prior periods.

In Step S144, a decision is made: if the nominal periodic distribution amount is greater than the highest prior periodic distribution amount without regard to caps, then control flows to Step S145. Otherwise, control flows to Step S1411. In Step S145, a decision is made: if the nominal periodic distribution amount is greater than the withdrawal restriction amount, the control flows to Step S148. Otherwise, control flows to Step S146. In Step S148, a decision is made: if the withdrawal restriction amount is greater than the prior periodic distribution amount, then control flows to Step S149 wherein the periodic distribution amount is set to the withdrawal restriction amount and the sub-process ends. Otherwise, control flows to Step S1410, wherein the periodic distribution amount is set to the prior periodic distribution amount and the sub-process ends. In Step S146, a decision is made: if the nominal periodic distribution amount is greater than the prior periodic distribution amount, then control flows to Step S147, wherein the periodic distribution amount is set to the nominal periodic distribution amount and the sub-process ends. Otherwise, control flows to Step S1410, wherein the periodic distribution amount is set to the prior periodic distribution amount and the sub-process ends. In Step S1411, a decision is made: if the highest prior periodic distribution amount without regard to caps is greater than the withdrawal restriction amount, then control flows to Step S148 and the process continues as described above. Otherwise, control flows to Step S1412, wherein a decision is made: if the highest prior periodic distribution amount without regard to caps is greater than the prior periodic distribution amount, then control flows to Step S1413 wherein the periodic distribution amount is set to the highest prior periodic distribution amount without regard to caps and the sub-process ends. Otherwise, if the highest prior periodic distribution amount without regard to caps is not greater than the prior periodic distribution amount, then control flows to Step S1410, wherein the periodic distribution amount is set to the prior periodic distribution amount and the sub-process ends as above.

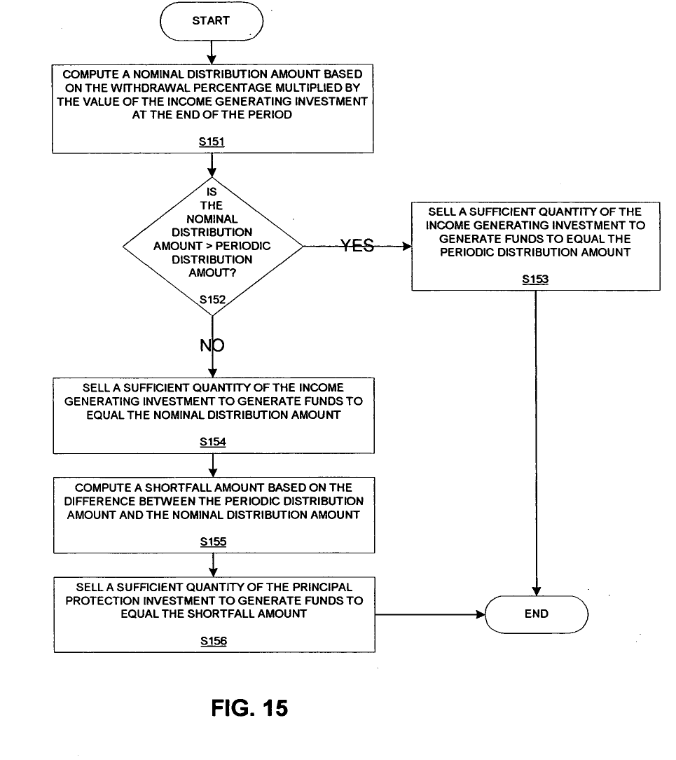

Turning to FIG. 15, the details of a second embodiment of Step S116 are illustrated in a flowchart. FIG. 15 depicts an example of determining how to fund the periodic distribution amount using a Type B distribution method. In Step S151, a nominal distribution amount is computed based on the withdrawal percentage multiplied by the value of the income generating investment at the end of the period. In Step S152, a decision is made: if the nominal distribution amount is greater than the periodic distribution amount, then control flows to Step S153 wherein a sufficient quantity of the income generating investment is sold to generate funds to equal the periodic distribution amount and the sub-process ends. Otherwise, control flows to Step S154 wherein a sufficient quantity of the income generating investment is sold to generate funds to equal the nominal distribution amount. In Step S155, a shortfall amount is computed based on the difference between the prior periodic distribution amount and the nominal distribution amount. In Step S156, a sufficient quantity of the principal protection investment is sold to generate funds to equal the shortfall amount and the sub-process ends.

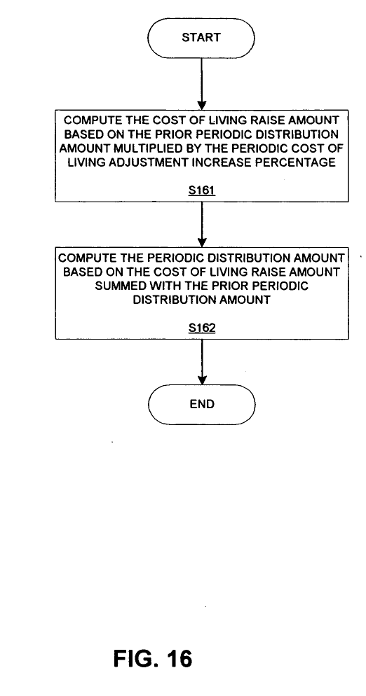

Turning to FIG. 16, the details of a third embodiment of Step S113 are illustrated in a flowchart. FIG. 16 depicts an example of determining a periodic distribution amount using a Type C distribution method. In Step S161, the cost of living raise amount is computed based on the prior periodic distribution amount multiplied by the periodic cost of living adjustment increase percentage. In Step S162, the periodic distribution amount is computed based on the cost of living raise amount summed with the prior periodic distribution amount and the sub-process ends.

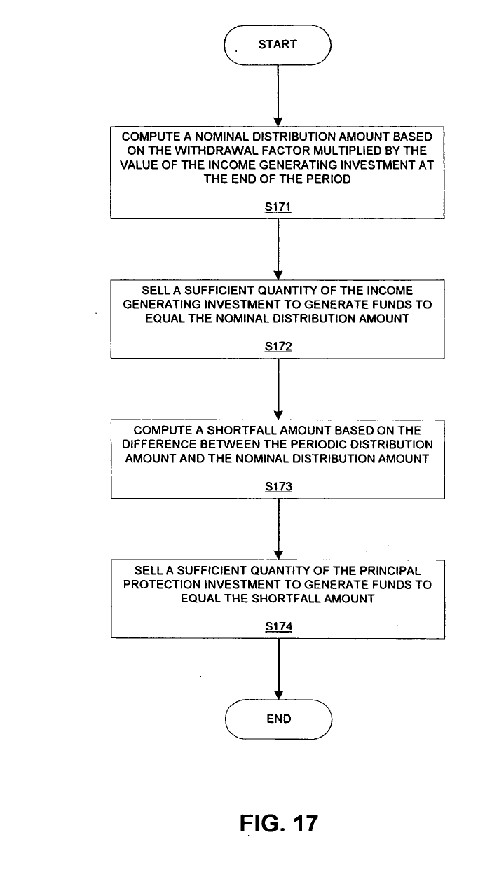

Turning to FIG. 17, the details of a third embodiment of Step S116 are illustrated in a flowchart. FIG. 17 depicts an example of determining how to fund the periodic distribution amount using a Type C distribution method. In Step S171, a nominal distribution amount is computed based on the withdrawal factor multiplied by the value of the income generating investment at the end of the period. In Step S172, a sufficient quantity of the income generating investment is sold to generate funds to equal the nominal distribution amount. In Step S173, a shortfall amount is computed based on the difference between the prior periodic distribution amount and the nominal distribution amount. In Step S174, a sufficient quantity of the principal protection investment is sold to generate funds to equal the shortfall amount and the sub-process ends.

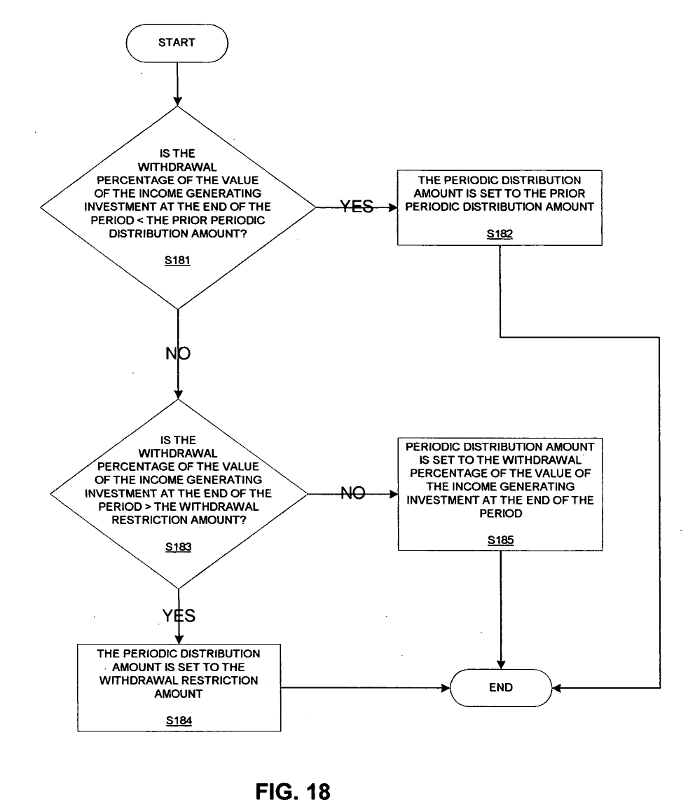

Turning to FIG. 18, the details of a fourth embodiment of Step S113 are illustrated in a flowchart. FIG. 18 depicts an example of determining a periodic distribution amount using a Type D distribution method. In Step S181, a decision is made: if the withdrawal percentage of the value of the income generating investment at the end of the period is less than the prior periodic distribution amount, then control flows to Step S182. Otherwise, control flows to Step S183. In Step S182, the periodic distribution amount is set to the prior periodic distribution amount and the sub-process ends. In Step S183, a decision is made: if the withdrawal percentage of the value of the income generating investment at the end of the period is greater than the withdrawal restriction amount, then control flows to Step S184. Otherwise, control flows to Step S185. In Step S184, the periodic distribution amount is set to the withdrawal restriction amount and the sub-process ends. In Step S185, the periodic distribution amount is set to the withdrawal percentage of the value of the income generating investment at the end of the period and the sub-process ends.

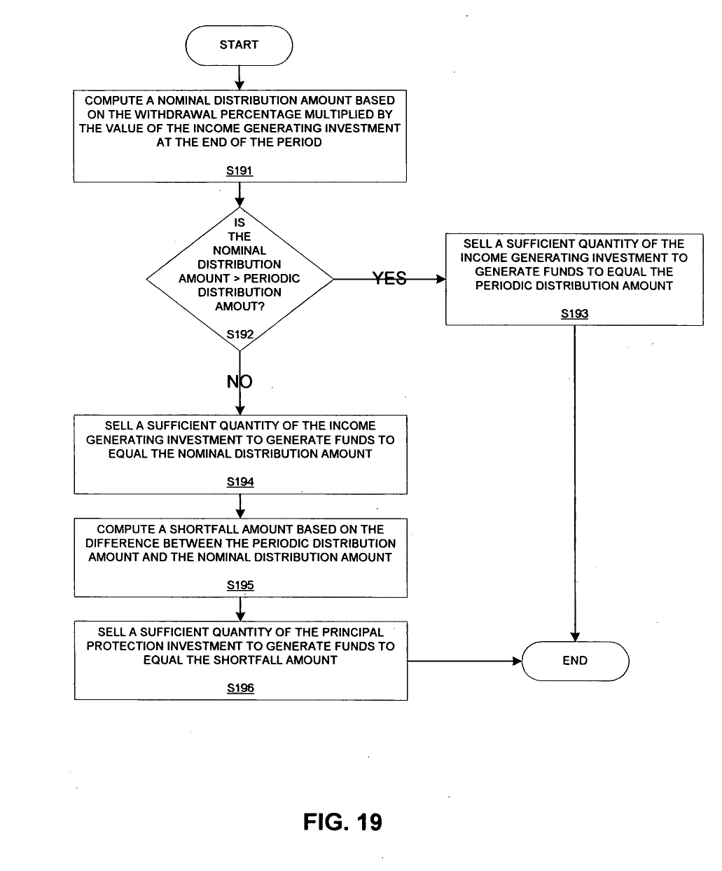

Turning to FIG. 19, the details of a fourth embodiment of Step S116 are illustrated in a flowchart. FIG. 19 depicts an example of determining how to fund the periodic distribution amount using a Type D distribution method. In Step S191, a nominal distribution amount is computed based on the withdrawal percentage multiplied by the value of the income generating investment at the end of the period. In Step S192, a decision is made: if the nominal distribution amount is greater than the periodic distribution amount, then control flows to Step S193 wherein a sufficient quantity of the income generating investment is sold to generate funds to equal the periodic distribution amount and the sub-process ends. Otherwise, control flows to Step S194 wherein a sufficient quantity of the income generating investment is sold to generate funds to equal the nominal distribution amount. In Step S195, a shortfall amount is computed based on the difference between the prior periodic distribution amount and the nominal distribution amount. In Step S196, a sufficient quantity of the principal protection investment is sold to generate funds to equal the shortfall amount and the sub-process ends.

### F. EXAMPLES

The following very specific hypothetical examples are provided to illustrate particular embodiments of the present invention, particularly from the perspective of potential users of the invention, such as clients and/or distribution outlets.

### Example 1

A healthy, 64 year old client who is close to retirement has managed to save approximately $1,000,000 that he desires to put into in a stable, long term, sustainable and regularly increasing income stream producing investment. Based on his life style, the client has determined that he will need to withdraw a minimum of approximately $60,000 per year from the beginning of his retirement. Although the client is not completely risk adverse, he is very concerned about the large fluctuations in the market over the past few years.

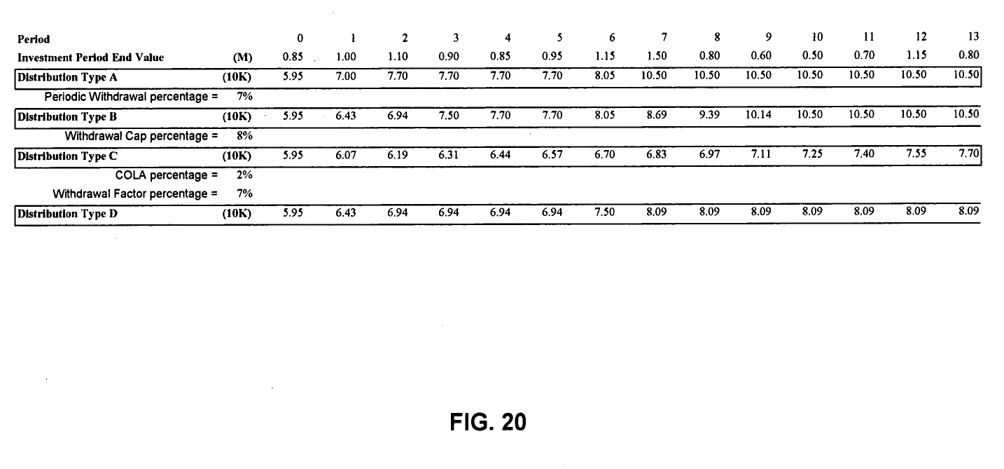

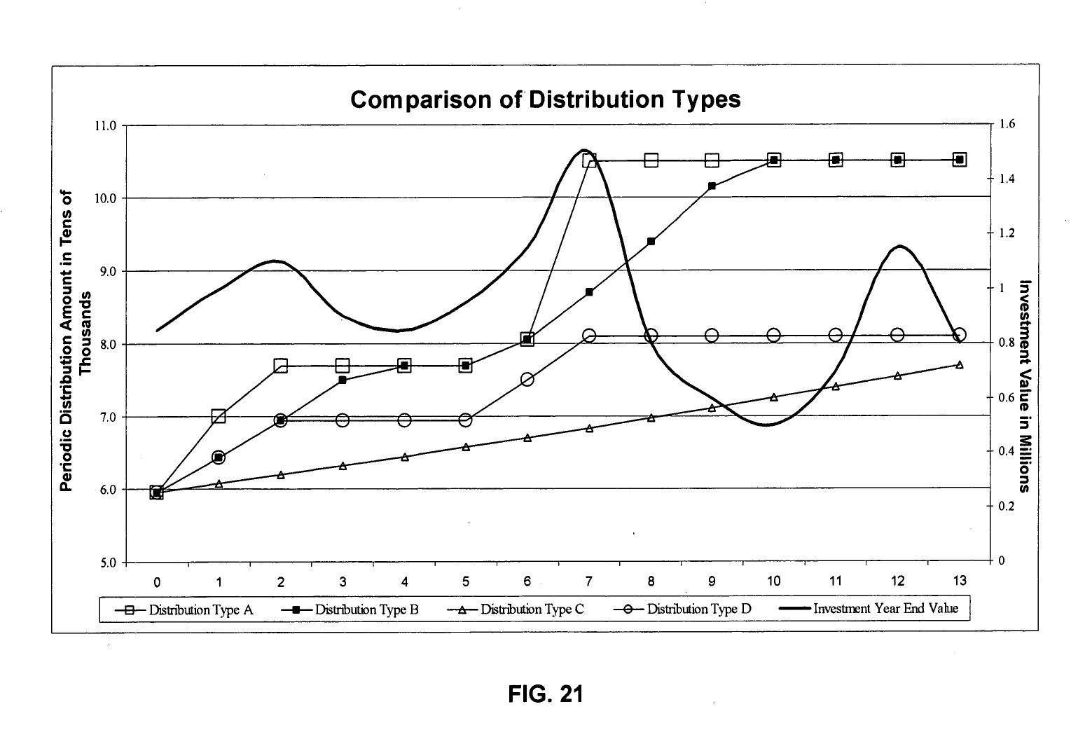

To help the client understand different distribution types and to select a distribution type, an advisor at a distribution outlet prepared the hypothetical illustrations depicted in FIGS. 20 and 21. FIG. 20 is a table comparing four distribution types labeled A through D. FIG. 21 is a graph illustrating the numeric information in the table of FIG. 20. The advisor explains that curve 2100 represents a wildly fluctuating worse-than-worst case scenario of the value of the client's investment in the income generating investments. In fact, the advisor explains, the hypothetical investments depicted in FIGS. 20 and 21 could never qualify to be selected for inclusion in the portfolio of possible investments that the advisor would recommend considering. The scale for curve 2100 is on the right hand side of the graph. Note that the value of the client's income generating investments ranges over $1,000,000, 50% above and below the client's initial investment amount within the span of just ten years.

The advisor further explained that curves 2102, 2104, 2106, and 2108 represent the hypothetical annual distribution amounts over time of distribution Types A through D, respectively. From the graph, it was clear that even in down markets, each of the distribution types increased the distribution amount over time. The client noticed that Type A (curve 2102) increased the fastest, rising quickly in up markets and holding level in down markets, and that Type B (curve 2104) delayed making raises and only slowly increased the distribution amount, but can do so even in down markets. The advisor explained that Type C (line 2106) provided a consistent increase completely independent of the market's performance while Type D (curve 2108) provided a slight raise when the market was up and held level when the market was down. The client was able to use this information to select the distribution type that best matched his expectations and needs. The client indicated to the advisor that the Type B distribution seemed to provide the appropriate balance between increasing the distribution amount and holding some value in reserve to improve growth potential. The advisor explained that there were another factors to consider.

### Example 2

Next, the advisor provided the illustration of FIG. 7. FIG. 7 depicts summary results information for each of the different distribution types using actual historical net asset value data. The advisor pointed out that this example shows that although the total payment amounts (ROW 710) for each of distribution Types A (COL 700), B (COL 702), and D (COL 706) maybe very similar, the total portfolio balance (ROW 712) for each of distribution Types A (COL 700), B (COL 702), and D (COL 706) may vary significantly, in this case by approximately $4,000,00. The client understood that by withdrawing less from the income generating investments by using Type D distribution method, more principal was available to earn income. And conversely, the more rapidly raises are received by using Type A distribution, the less principal there is available to earn income. The client confirmed that he liked the balance between the rate of receiving raises and the size of the end balance that Type B distribution offers.

### Example 3

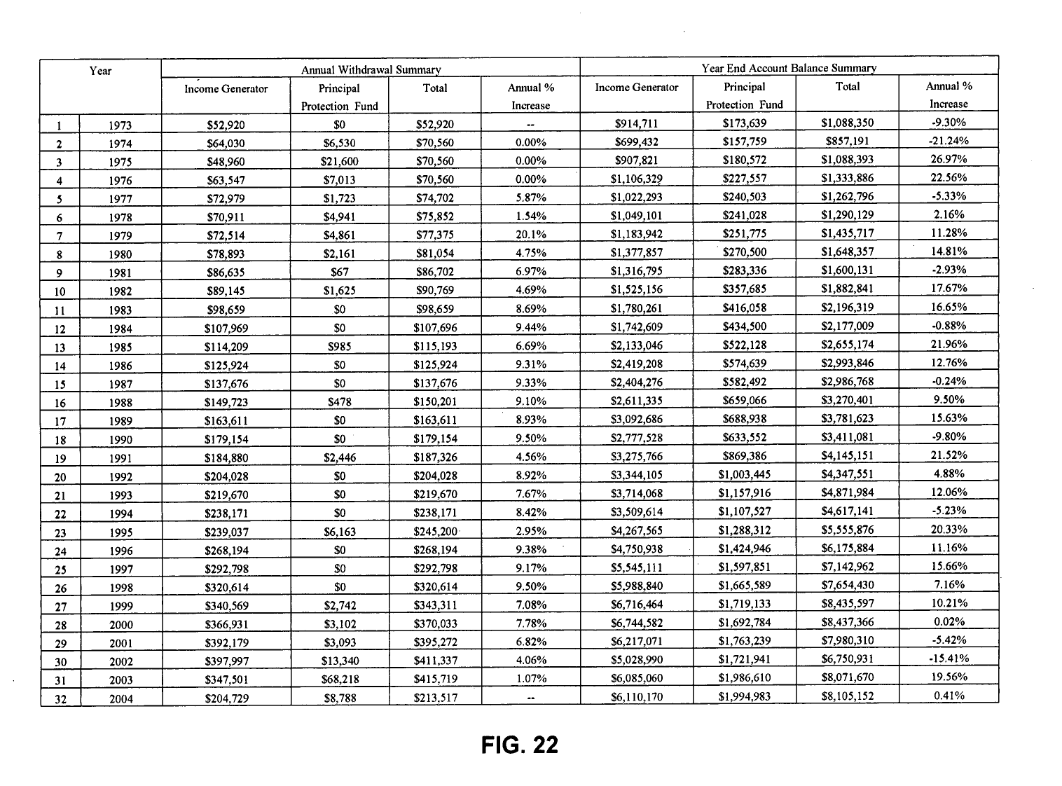

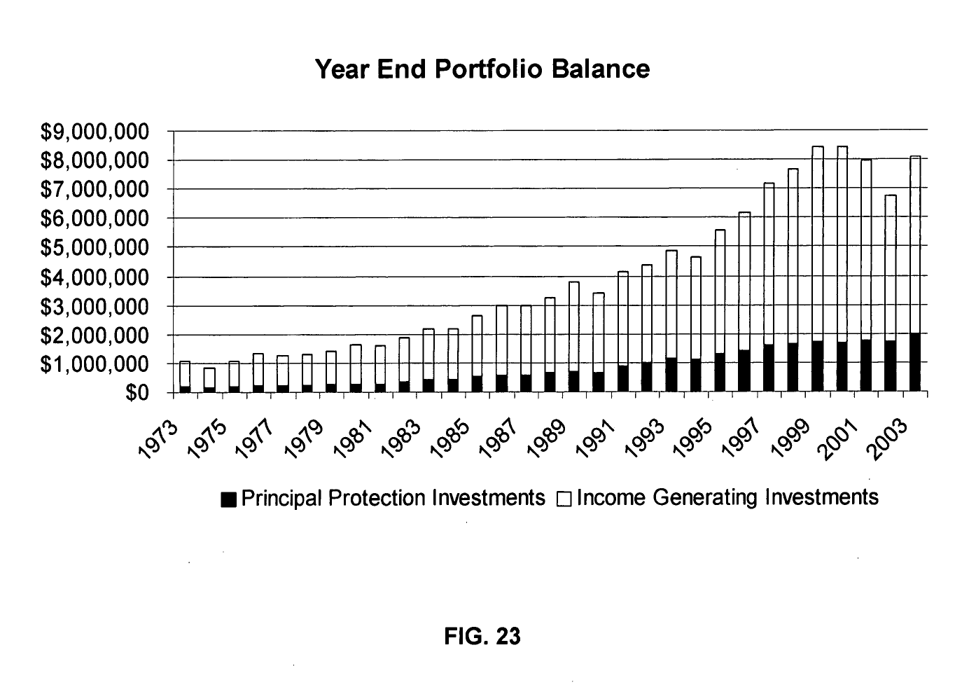

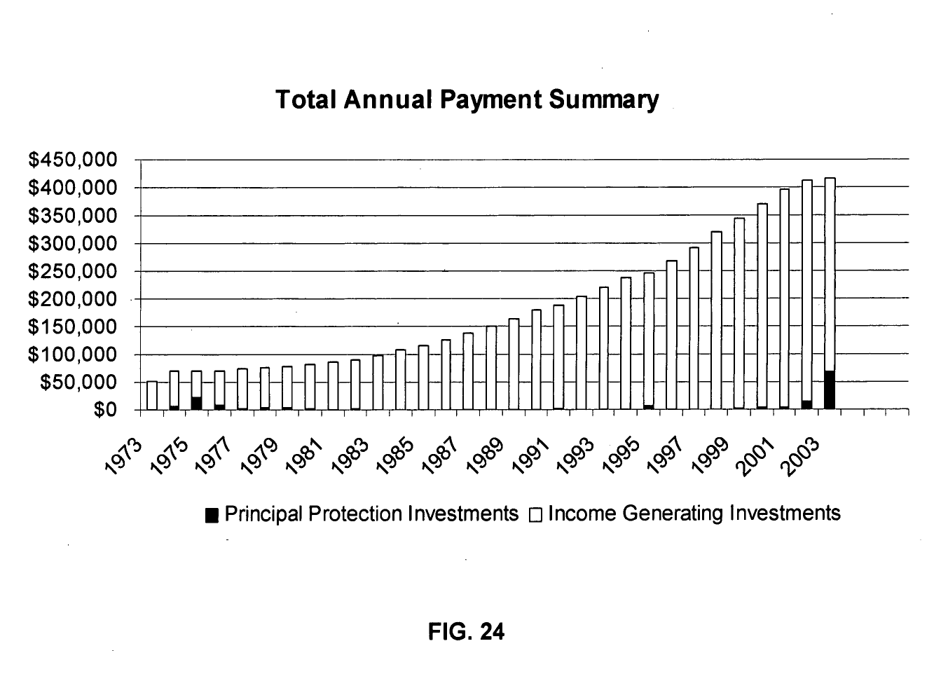

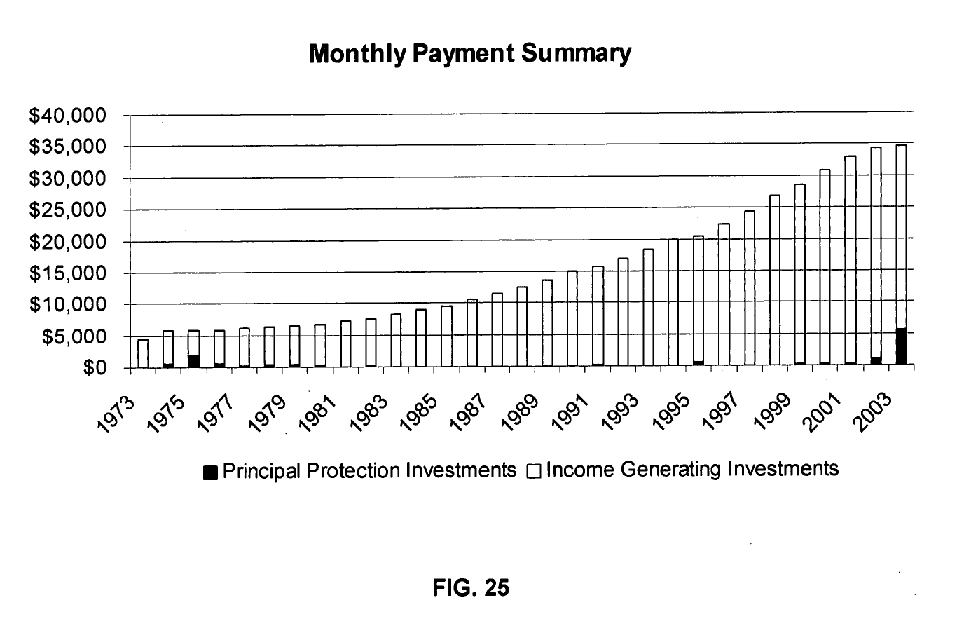

Finally, the advisor provided the illustrations of FIGS. 22 through 25. These drawings illustrate an example of the results achieved by applying a Type B distribution method to historical NAV data reflecting some of the worst financial events in the past forty years. For example, the method is tested against data from Mar. 31, 1973 (before the six-quarter crash of '73 and '74), Sep. 30^{th} of 1987 (just prior to the crash of '87), Mar. 31, 2000 (just as the Nasdaq peaked and the markets fell apart in 2000 through 2002), and Aug. 31, 2001 (just prior to the Sep. 11, 2001 tragedy and where the markets closed for a record four days opening to an unequalled level of uncertainty.) FIG. 22 is a table illustrating the performance of an example investment portfolio and the results of applying a Type B distribution method. FIG. 23 is a graph depicting the growth of the investment and the relative contributions of the income generating investments and the principal protection investments. FIG. 24 is a graph depicting the growth of the annual distribution amount and the relative contributions of the income generating investments and the principal protection investments. FIG. 25 is a graph depicting the growth of the monthly distribution amount and the relative contributions of the income generating investments and the principal protection investments.

### Example 4

Client W, a 90 year old widow, lives in an assisted living facility. Her only child, a 61 year old male, has the responsibility of managing his mother's remaining assets. He is her sole heir and has the responsibility to care for her within her current means. She has no other assets; Client W's home was sold several years ago to pay for the assisted living facility.

Client W and her late husband had invested 100% of their liquid capital in closed end mutual funds solely invested in high yield junk bonds within the last ten years. This was a decision made by Client W and her late husband without the son's assistance and implemented with a broker in their state of residence, New Jersey.

The market volatility had erased more than 50% of the value of their original investment. The son needed to invoke the privileges of the bona fide power of attorney in late 2003 when the mother was hospitalized in critical condition. There is a fixed sum of monthly cash flow that Client W requires as her stipend to the facility. Her only other income is from Social Security.

The son sought an advisor to help define what his mother would need for cash flow from Client W's assets. Based upon Client W's advanced age, declining health, immediate financial needs, and her significantly eroded principal, the advisor determined that conventional investment strategies would not support the required cash flow. Client W needed a way to generate cash flow while preserving principal with liquidity-based alternatives.

The decision was made to liquidate the existing portfolio and allocate the funds according to the present invention in a very aggressive risk and withdrawal profile. Ninety percent of the funds were put into income generating investments and ten percent was allocated to principal protection investments. Distribution Type A was selected with a withdrawal rate of eight percent. This decision was made based upon the following primary factors: Client W is expected to live only a few more years at the maximum but she may live longer; there is a likelihood that Client W may not have the opportunity to enjoy luxuries; she may only survive for a longer time; and Client W is in poor health and needs a high level of cash flow from her remaining assets.

It is anticipated that as the markets recover, the withdrawal rate will be held constant. Adjustments to move away from Client W's initial extremely aggressive position may be made if the opportunity presents itself.

### Example 5

Client H is a widow aged 45. She became a widow at age 40 with two young children ages 10 and 7. Client H's husband had died leaving a young family, few debts and an ample amount of life insurance and assets accumulated. The family bought a more modest home without a mortgage. By employing the present invention, Client H is able to remain a stay-at-home Mom and not have to work for income.

While Client H's needs are relatively modest, the family is accustomed to an above-average but not an extravagant lifestyle. Opting to remain a homemaker, Client H determined what traditional investment methods would likely yield and what she wanted for an income. The disparity between the two made it clear that conventional investment strategies would not serve. An advisor illustrated how the methods of the present invention may be applied to generate a specific amount of income from Client H's assets and to use only those assets necessary to generate that income supply. Using the present invention in a relatively conservative configuration, the minimum necessary assets to meet Client H's income requirements were allocated with 84% being invested in income generating investments and 16% invested in principal protection investments with a 6.5% withdrawal rate. All other assets, not needed to produce income, were held strategically in qualified plan accounts, free of current income tax, and in special trusts or deferred compensation plans with Client H's deceased husband's last employer.

Client H's investment plan was initiated just as the recession of 2000-2002 started. Her withdrawal rate was conservative and she had seen some historical evidence of the same. The markets were battered from the outset. Her downside was significantly less than the markets as measured by either the DJIA or the S&P 500. In addition to the falling base principal, Client H actively surrendered investment units for income.

Four years later, Client H's portfolio is poised to provide a raise in income but Client H has declined the raise. Client H has determined she does not need it. Her assets swayed some with the stormy markets but through reliance on the present invention, Client H's asset base is larger than when she started four years ago, her income has been steady at a rate over $150k per year, and her realized income has never dropped.

### Example 6

A couple age 62 and 61 are both enjoying fine health. They have two adult age children, two grandchildren and paid-for residences. The pension income and Social Security income (projected and received) are solid but not sufficient to support their lifestyle desires.

This couple lives fully but not in an extravagant way. They are very generous to charity and overly generous to their kids and grandkids. They have a want for income that exceeds the conventional limits of retirement investing but it is not excessive.

The income shortfall in 2003-2005 is real. There are some additional corporate income benefits that are expected to be received in two years. There has been an income gap in the last year and there is one now. Further, the income gap is expected to reappear fifteen years from now. The couple perceives a need for “bridge income.”

This hypothetical situation provides a classic example of establishing a pattern of turning on and turning off a configuration of income from assets. Using the present invention to deploy money as a tool, the inventive investment methodology may be used to leverage life. The couple's present income challenge will be eliminated in 2006 but it is impacting their lives now and shall again in fifteen years when the other benefits cease.

The present invention may be engaged to move the couple's assets into a systematic methodology for generating income and to turn off that income supply when the need and/or want passes. The inventive income methodology may be configured to generate the income if it is needed. The couple's $1.6 million in assets were allocated with 84% being invested in income generating investments and 16% invested in principal protection investments with a 7% withdrawal rate. In this configuration, the present invention will generate the couple's income for the three year shortfall. The initial shortfall is approximately $95k in 2003 and a little less in years 2004 and 2005.

When there is no shortfall in 2006, the income will not be required and withdrawals will be suspended. After fifteen years, the withdrawals may be reactivated as needed.

### G. ADDITIONAL EMBODIMENTS OF THE INVENTION

The foregoing description discloses only exemplary embodiments of the invention. Modifications of the above disclosed apparatus and methods which fall within the scope of the invention will be readily apparent to those of ordinary skill in the art. The following are example alternative variations which illustrate additional embodiments of the present invention. It should be understood that the particular variations described in this section may be combined with the different embodiments, or portions thereof, described above in any manner that is practicable. These examples do not constitute a definition or itemization of all possible embodiments, and those skilled in the art will understand that the present invention is applicable to many other embodiments. Further, although the following examples are briefly described for clarity, those skilled in the art will understand how to make any changes, if necessary, to the above-described apparatus and methods to accommodate these and other embodiments and applications.

In some embodiments, the present invention may include the additional function of determining an amount to charge for each transaction associated with managing a portfolio according to the present invention.

In some embodiments, the present invention may include the additional function of performing automated updates to the historical net asset value database 308 from online data sources.

In some embodiments, many alternative distribution methods may be employed including combinations of the four type described above. For example, in some embodiments, an investor may desire to suspend withdrawals or alter allocation percentages to adjust for changed circumstances.

### H. CONCLUSION

It is clear from the foregoing discussion that the disclosed systems and methods for investment portfolio selection, allocation, and management to generate sustainable withdrawals represents an improvement in the arts of electronic commerce, financial management, and investing. While the methods and apparatus of the present invention has been described in terms of presently preferred and alternate exemplary embodiments, those skilled in the art will recognize that the present invention may be practiced with modification and alteration within the spirit and scope of the appended claims. The specifications and drawings are, accordingly, to be regarded in an illustrative rather than a restrictive sense.

Further, even though only certain embodiments have been described in detail, those having ordinary skill in the art will certainly appreciate and understand that many modifications, changes, enhancements, and other embodiments are possible without departing from the teachings thereof All such modifications are intended to be encompassed within the following claims.

What is claimed is:

1. A method comprising:
determining an investment amount for purchasing an investment;
determining a minimum distribution rate;
allocating the investment amount among a plurality of individual investments of different types, collectively referred to as the investment;
determining a distribution amount based upon a performance level of at least one of the plurality of individual investments and the minimum distribution rate; and
determining at least a portion of at least one individual investment from among the plurality of individual investments to liquidate to fund the distribution amount,
wherein the minimum distribution rate is greater than a predefined percentage of a current value of the investment per year and is maintained at a level at least equal to a highest level of all prior years.

2. The method of claim 1, wherein the different types include at least two different types having contrary investment philosophies.

3. The method of claim 1, wherein the different types include at least two different types and the investment amount is allocated between the different types based upon a predefined ratio.

4. The method of claim 3 wherein the ratio is determined based upon historical investment data.

5. The method of claim 3 wherein the ratio is determined such that the minimum distribution rate can be maintained for longer than a predefined term if, based upon historical investment data, the investment performs at least equal to the investment's worst performance over a term prior to purchase and having a length determined based upon the predefined term.

6. The method of claim 5 wherein the predefined term is approximately at least 30 years.

7. The method of claim 3 wherein the ratio is determined such that the minimum distribution rate can be maintained indefinitely if, based upon historical investment data, the plurality of individual investments collectively performs at least equal to the plurality of individual investments' worst prior performance.

8. The method of claim 1, wherein the different types include at least five different types, the investment amount is allocated between the different types based upon a predefined ratio, and one of the types is characterized by an investment philosophy that is contrary to an investment philosophy of others of the types.

9. The method of claim 8, wherein the different types include large capitalization value investments, balanced hybrid investments, global value growth investments, large capitalization growth investments, and bond investments.

10. The method of claim 9, wherein the investment amount is allocated between bond investments and the others of the types of investments based on a ratio of approximately 4:21.

11. The method of claim 10, wherein approximately 86% of the investment amount is allocated among the other types of investments based on predefined percentages including: approximately 41% allocated to large capitalization value investments, approximately 30% allocated to balanced hybrid investments, approximately 20% allocated to global value growth investments, and approximately 9% allocated to large capitalization growth investments.

12. The method of claim 8 wherein the ratio is determined based upon historical investment data.

13. The method of claim 8 wherein the ratio is determined such that the minimum distribution rate can be maintained for longer than a predefined term if, based upon historical investment data, the investment performs at least equal to the investment's worst prior performance over a term prior to purchase and having a length determined based upon the predefined term.

14. The method of claim 13 wherein the predefined term is approximately at least 30 years.

15. The method of claim 8 wherein the ratio is determined such that the minimum distribution rate can be maintained indefinitely if, based upon historical investment data, the plurality of individual investments collectively performs at least equal to the plurality of individual investments' worst prior performance.

16. The method of claim 1 wherein the distribution amount is paid periodically and the minimum distribution rate is determined periodically.

17. The method of claim 16 wherein the distribution amount is paid out based upon a first period and the minimum distribution rate is determined based upon a second period.

18. The method of claim 17 wherein the first period is monthly and the second period is annually.

19. The method of claim 1, wherein the distribution amount may be increased by an adjustment amount as the minimum distribution rate changes.

20. The method of claim 19, wherein the adjustment amount is limited if the current value of the investment increases to an amount greater than all prior values of the investment.

21. The method of claim 1 wherein the predefined percentage of the current value of the investment is approximately at least six percent.

22. A method comprising:
determining an investment amount;
determining a minimum distribution rate;
allocating the investment amount among a plurality of investments of different types;
determining a distribution amount based on a predefined periodic adjustment and independent of a performance level of the plurality of investments; and
determining at least a portion of at least one investment from among the plurality of investments to liquidate to fund the distribution amount,
wherein the minimum distribution rate is greater than a predefined percentage of the investment amount per year.

23. The method of claim 22, wherein the different types include at least two different types having contrary investment philosophies.

24. The method of claim 22, wherein the different types include at least two different types and the investment is allocated between the different types based upon a predefined ratio.

25. The method of claim 24 wherein the ratio is determined based upon historical investment data.

26. The method of claim 24 wherein the ratio is determined such that the minimum distribution rate can be maintained for longer than a predefined term if, based upon historical investment data, the plurality of investments collectively performs at least equal to the plurality of investments' worst prior performance.

27. The method of claim 22 wherein the predefined periodic adjustment is an increasing amount from period to period.

28. The method of claim 22 wherein the predefined periodic adjustment is determined based upon a cost of living historical information.

29. The method of claim 22 wherein the predefined periodic adjustment is determined based upon a cost of living index.

30. The method of claim 22 wherein the predefined percentage of the investment is approximately at least six percent.

31. A method comprising:
selecting at least two investments having contrary investment philosophies;
investing a first portion of an investment amount in a first one of the investments;
investing a second portion of the investment amount in a second one of the investments;
reinvesting, over time, any earnings from the investments back into the investments;
determining, periodically, a distribution amount that is equal to or greater than a distribution amount of a prior period based upon a performance level of at least one of the investments;
selling a portion of the first one of the investments sufficient to fund the distribution amount if the determined distribution amount is greater than the distribution amount of the prior period; and
selling a portion of the first one of the investments in an amount based on any growth in value of the first one of the investments to fund a first part of the distribution amount and selling a portion of the second one of the investments sufficient to fund a second part of the distribution amount such that the first part and second part sum to equal the determined distribution amount, if the amount, if any, of the first one of the investments is less than the determined distribution amount.

32. The method of 31 wherein the investments are selected from a set of investments and wherein the set of investments is determined based upon a plurality of historical performance factors including a downside deviation rating, a Sortino ratio, an upside potential ratio, and a downside risk-adjusted return rating.

33. The method of 32 wherein the set of investments is limited to investments with a downside deviation rating smaller than the average downside deviation rating of all investments that have historically performed above a predefined threshold.

34. The method of 32 wherein the set of investments is limited to investments that have a Sortino ratio larger than an average Sortino ratio of all investments that have historically performed above a predefined threshold.

35. The method of 32 wherein the set of investments is limited to investments that have an upside potential ratio larger than an average upside potential ratio of all investments that have historically performed above a predefined threshold.

36. The method of 32 wherein the set of investments is limited to investments that have a downside risk-adjusted return rating larger than an average downside risk-adjusted return rating of all investments that have historically performed above a predefined threshold.

37. A method comprising:
investing in at least one income generating investment;
investing in at least one principal protection investment; and
drawing a periodic distribution amount from the investments based upon a withdrawal percentage of a value of the at least one income generating investment, the periodic distribution amount being equal to or greater than all prior periodic distribution amounts,
wherein the distribution is funded first by
selling a portion of the at least one income generating investment, and second by
selling a portion of the at least one principal protection investment if the withdrawal percentage of the value of the at least one income generating investment is insufficient to fund the periodic distribution amount.

38. The method of claim 37 wherein the periodic distribution amount is determined based upon the value of the at least one income generating investment at the end of a period, the withdrawal percentage, and a prior periodic distribution amount.

39. The method of claim 37 wherein the periodic distribution amount is equal to the withdrawal percentage of the value of the at least one income generating investment at the end of a period unless the withdrawal percentage of the value of the at least one income generating investment at the end of the period is less than the prior periodic distribution amount, in which case the prior periodic distribution amount is used as the periodic distribution amount.

40. The method of claim 38 wherein the periodic distribution amount is equal to MAX(P′,(V*W)) wherein P′ represents the prior periodic distribution amount, V represents the value of the at least one income generating investment at the end of the period, and W represents the withdrawal percentage.

41. The method of claim 38 wherein selling a portion of the at least one principal protection investment includes selling a sufficient quantity of the principal protection investment to generate funds sufficient to equal a difference between the prior periodic distribution amount and the withdrawal percentage multiplied by the value of the at least one income generating investment at the end of the period.

42. The method of claim 37 wherein the periodic distribution amount is determined based upon the value of the at least one income generating investment at the end of a period, the withdrawal percentage, a prior periodic distribution amount, a withdrawal restriction amount, and a highest periodic distribution amount of all prior periods without regard to any withdrawal restrictions.

43. The method of claim 37 wherein the periodic distribution amount is equal to the withdrawal percentage of the value of the at least one income generating investment at the end of a period unless,
the withdrawal percentage of the value of the at least one income generating investment at the end of the period is less than the prior periodic distribution amount, in which case the prior periodic distribution amount is used as the periodic distribution amount, or
the withdrawal percentage of the value of the at least one income generating investment at the end of the period is greater than a withdrawal restriction amount, in which case a greater of the prior distribution amount and the withdrawal restriction amount is used as the periodic distribution amount, or
the value of the at least one income generating investment at the end of the period is greater than it has been at the end of all prior periods, in which case a greater of the prior distribution amount and the withdrawal restriction amount is used as the periodic distribution amount unless,
the withdrawal percentage of a highest value of the at least one income generating investment at the end of all prior periods is less than the withdrawal restriction amount, in which case a greater of the prior distribution amount and the withdrawal percentage of the highest value of the at least one income generating investment at the end of all prior periods is used as the periodic distribution amount.

44. The method of claim 43 wherein the withdrawal restriction amount is determined based upon the prior periodic distribution amount summed with a product of multiplying the prior periodic distribution amount and a withdrawal cap percentage.

45. The method of 42, wherein the periodic distribution amount is equal to MAX(P,MIN(H,R))), wherein P represents the prior periodic distribution amount, H represents the highest periodic distribution amount of all prior periods without regard to any withdrawal restrictions, and R represents the withdrawal restriction amount.

46. The method of claim 45, wherein the highest periodic distribution amount of all prior periods without regard to any withdrawal restrictions (H) equals MAX(P′,(V*W)) wherein P′ represents the prior periodic distribution amount determined without regard to any withdrawal restrictions, V represents the value of the at least one income generating investment, and W represents the withdrawal percentage.

47. The method of claim 46, wherein the prior periodic distribution amount determined without regard to any withdrawal restrictions (P′) equals (V′*W) wherein V′ represents a highest value of the at least one income generating investment at the end of all prior periods

48. The method of claim 45, wherein the withdrawal restriction amount (R) is equal to P*(C+1) wherein C represents a withdrawal cap percentage.

49. The method of claim 42 wherein selling a portion of the at least one principal protection investment includes selling a sufficient quantity of the principal protection investment to generate funds sufficient to equal a difference between the periodic distribution amount and the value of the at least one income generating investment at the end of the period multiplied by the withdrawal percentage, if the value of the at least one income generating investment multiplied by the withdrawal percentage is less than the periodic distribution amount.

50. The method of claim 37 wherein the periodic distribution amount is determined based upon an initial value of the at least one income generating investment, the withdrawal percentage, and a cost of living adjustment amount.

51. The method of claim 37 wherein the periodic distribution amount is equal to a prior periodic distribution amount summed with a product of multiplying the prior periodic distribution amount and a cost of living adjustment amount.

52. The method of claim 37 wherein the periodic distribution amount is determined based upon a prior periodic distribution amount and a dynamic percentage raise amount.

53. The method of claim 37 wherein the periodic distribution amount is determined based upon a prior periodic distribution amount and a percentage raise amount.

54. The method of claim 53 wherein selling a portion of the at least one principal protection investment includes selling a sufficient quantity of the principal protection investment to generate funds sufficient to equal a difference between
the prior periodic distribution amount multiplied by the percentage raise amount and
the withdrawal percentage of the value of the at least one income generating investment at an end of the prior period.

55. The method of claim 53 wherein selling a portion of the at least one principal protection investment includes selling a sufficient quantity of the principal protection investment to generate funds sufficient to equal the difference between
the prior periodic distribution amount multiplied by the percentage raise amount and
a withdrawal factor multiplied by a current value of the at least one income generating investment.

56. The method of claim 37 wherein the periodic distribution amount is determined based upon the value of the at least one income generating investment at the end of a period, the withdrawal percentage, a prior periodic distribution amount, and a withdrawal restriction amount.

57. The method of claim 37 wherein the periodic distribution amount is equal to the withdrawal percentage of the value of the at least one income generating investment at the end of a period unless either,
the withdrawal percentage of the value of the at least one income generating investment at the end of the period is less than a prior periodic distribution amount, in which case the prior periodic distribution amount is used as the periodic distribution amount, or
the withdrawal percentage of the value of the at least one income generating investment at the end of the period is more than a withdrawal restriction amount, in which case the withdrawal restriction amount is used as the periodic distribution amount.

58. The method of claim 57 wherein the withdrawal restriction amount is determined based upon the prior periodic distribution amount summed with a product of multiplying the prior periodic distribution amount and a withdrawal cap percentage.

59. The method of 56, wherein the periodic distribution amount is equal to MAX(P,MIN(V*W,R))), wherein P represents the prior periodic distribution amount, V represents the value of the at least one income generating investment at the end of the period, W represents the withdrawal percentage, and R represents the withdrawal restriction amount.

60. The method of claim 59, wherein the withdrawal restriction amount (R) is equal to P*(C+1) wherein C represents a withdrawal cap percentage.

61. The method of claim 56 wherein selling a portion of the at least one principal protection investment includes selling a sufficient quantity of the principal protection investment to generate funds sufficient to equal a difference between the periodic distribution amount and the withdrawal percentage of the value of the at least one income generating investment at the end of the period, if the withdrawal percentage of the value of the at least one income generating investment at the end of the period is less than the periodic distribution amount.

62. A method comprising:
determining an investment amount for purchasing an investment;
determining a minimum distribution rate;
allocating the investment amount among a plurality of individual investments of different types, collectively referred to as the investment, based upon predefined ratios and historical performance information;
determining a distribution amount based upon a performance level of at least one of the plurality of individual investments and the minimum distribution rate; and
determining at least a portion of at least one individual investment from among the plurality of individual investments to liquidate to fund the distribution amount,
wherein the minimum distribution rate is never decreased and the distribution amount is paid out indefinitely as long as the investment performs no worse than the historical performance information indicates.

63. The method of claim 62 wherein the predefined ratios are determined based upon historical investment data.

64. The method of claim 62 wherein the predefined ratios are determined such that the minimum distribution rate can be maintained for longer than a predefined term if, based upon historical investment data, the investment performs at least equal to the investment's worst performance over a term prior to purchase and having a length determined based upon the predefined term.

65. The method of claim 64 wherein the predefined term is approximately at least 30 years.

66. The method of claim 62 wherein the predefined ratios are determined such that the minimum distribution rate can be maintained indefinitely if, based upon historical investment data, the plurality of individual investments collectively performs at least equal to the plurality of individual investments' worst prior performance.

67. The method of claim 62, wherein the different types include at least five different types, the investment amount is allocated between the different types based upon a predefined ratio, and one of the types is characterized by an investment philosophy that is contrary to an investment philosophy of others of the types.

68. The method of claim 67, wherein the different types include large capitalization value investments, balanced hybrid investments, global value growth investments, large capitalization growth investments, and bond investments.

69. The method of claim 68, wherein the investment amount is allocated between bond investments and the others of the types of investments based on a ratio of approximately 4:21.

70. The method of claim 69, wherein approximately 86% of the investment amount is allocated among the other types of investments based on predefined percentages including: approximately 41% allocated to large capitalization value investments, approximately 30% allocated to balanced hybrid investments, approximately 20% allocated to global value growth investments, and approximately 9% allocated to large capitalization growth investments.

71. The method of claim 62 wherein the ratio is determined such that the minimum distribution rate can be maintained for longer than a predefined term if, based upon historical investment data, the investment performs at least equal to the investment's worst prior performance over a term prior to purchase and having a length determined based upon the predefined term.

72. The method of claim E11 wherein the predefined term is approximately at least 30 years.

73. The method of claim 62 wherein the predefined ratios are determined such that the minimum distribution rate can be maintained indefinitely if, based upon historical investment data, the plurality of individual investments collectively performs at least equal to the plurality of individual investments' worst prior performance.

74. The method of claim 62 wherein the distribution amount is paid periodically and the minimum distribution rate is determined periodically.

75. The method of claim 74 wherein the distribution amount is paid out based upon a first period and the minimum distribution rate is determined based upon a second period.

76. The method of claim 75 wherein the first period is monthly and the second period is annually.

77. The method of claim 62, wherein the distribution amount may be increased by an adjustment amount as the minimum distribution rate changes.

78. The method of claim 77, wherein the adjustment amount is limited if the current value of the investment increases to an amount greater than all prior values of the investment.

79. The method of claim 62 wherein the minimum distribution rate is greater than a predefined percentage of the current value per year of the investment and is approximately at least six percent.

80. An apparatus comprising:
means for determining an investment amount for purchasing an investment;
means for determining a minimum distribution rate;
means for allocating the investment amount among a plurality of individual investments of different types, collectively referred to as the investment;
means for determining a distribution amount based upon a performance level of at least one of the plurality of individual investments and the minimum distribution rate; and
means for determining at least a portion of at least one individual investment from among the plurality of individual investments to liquidate to fund the distribution amount,
wherein the minimum distribution rate is greater than a predefined percentage of a current value of the investment per year and is maintained at a level at least equal to a highest level of all prior years.

81. The apparatus of claim 80, wherein the different types include at least two different types having contrary investment philosophies.

82. The apparatus of claim 80, wherein the different types include at least two different types and the investment amount is allocated between the different types based upon a predefined ratio.

83. The apparatus of claim 82 wherein the ratio is determined based upon historical investment data.

84. The apparatus of claim 82 wherein the ratio is determined such that the minimum distribution rate can be maintained for longer than a predefined term if, based upon historical investment data, the investment performs at least equal to the investment's worst performance over a term prior to purchase and having a length determined based upon the predefined term.

85. The apparatus of claim 84 wherein the predefined term is approximately at least 30 years.

86. The apparatus of claim 82 wherein the ratio is determined such that the minimum distribution rate can be maintained indefinitely if, based upon historical investment data, the plurality of individual investments collectively performs at least equal to the plurality of individual investments' worst prior performance.

87. The apparatus of claim 80, wherein the different types include at least five different types, the investment amount is allocated between the different types based upon a predefined ratio, and one of the types is characterized by an investment philosophy that is contrary to an investment philosophy of others of the types.

88. The apparatus of claim 87, wherein the different types include large capitalization value investments, balanced hybrid investments, global value growth investments, large capitalization growth investments, and bond investments.

89. The apparatus of claim 88, wherein the investment amount is allocated between bond investments and the others of the types of investments based on a ratio of approximately 4:21.

90. The apparatus of claim 89, wherein approximately 86% of the investment amount is allocated among the other types of investments based on predefined percentages including: approximately 41% allocated to large capitalization value investments, approximately 30% allocated to balanced hybrid investments, approximately 20% allocated to global value growth investments, and approximately 9% allocated to large capitalization growth investments.

91. The apparatus of claim 87 wherein the ratio is determined based upon historical investment data.

92. The apparatus of claim 87 wherein the ratio is determined such that the minimum distribution rate can be maintained for longer than a predefined term if, based upon historical investment data, the investment performs at least equal to the investment's worst prior performance over a term prior to purchase and having a length determined based upon the predefined term.

93. The apparatus of claim 92 wherein the predefined term is approximately at least 30 years.

94. The apparatus of claim 87 wherein the ratio is determined such that the minimum distribution rate can be maintained indefinitely if, based upon historical investment data, the plurality of individual investment's collectively performs at least equal to the plurality of individual investments' worst prior performance.

95. The apparatus of claim 80 wherein the distribution amount is paid periodically and the minimum distribution rate is determined periodically.

96. The apparatus of claim 95 wherein the distribution amount is paid out based upon a first period and the minimum distribution rate is determined based upon a second period.

97. The apparatus of claim 96 wherein the first period is monthly and the second period is annually.

98. The apparatus of claim 80, wherein the distribution amount may be increased by an adjustment amount as the minimum distribution rate changes.

99. The apparatus of claim 98, wherein the adjustment amount is limited if the current value of the investment increases to an amount greater than all prior values of the investment.

100. The apparatus of claim 80 wherein the predefined percentage of the current value of the investment is approximately at least six percent.

101. An apparatus comprising:
means for determining an investment amount;
means for determining a minimum distribution rate;
means for allocating the investment amount among a plurality of investments of different types;
means for determining a distribution amount based on a predefined periodic adjustment and independent of a performance level of the plurality of investments; and
means for determining at least a portion of at least one investment from among the plurality of investments to liquidate to fund the distribution amount,
wherein the minimum distribution rate is greater than a predefined percentage of the investment amount per year.

102. The apparatus of claim 101, wherein the different types include at least two different types having contrary investment philosophies.

103. The apparatus of claim 101, wherein the different types include at least two different types and the investment is allocated between the different types based upon a predefined ratio.

104. The apparatus of claim 103 wherein the ratio is determined based upon historical investment data.

105. The apparatus of claim 103 wherein the ratio is determined such that the minimum distribution rate can be maintained for longer than a predefined term if, based upon historical investment data, the plurality of investments collectively performs at least equal to the plurality of investments' worst prior performance.

106. The apparatus of claim 101 wherein the predefined periodic adjustment is an increasing amount from period to period.

107. The apparatus of claim 101 wherein the predefined periodic adjustment is determined based upon a cost of living historical information.

108. The apparatus of claim 101 wherein the predefined periodic adjustment is determined based upon a cost of living index.

109. The apparatus of claim 101 wherein the predefined percentage of the investment is approximately at least six percent.

110. An apparatus comprising:
means for selecting at least two investments having contrary investment philosophies;
means for investing a first portion of an investment amount in a first one of the investments;
means for investing a second portion of the investment amount in a second one of the investments;
means for reinvesting, over time, any earnings from the investments back into the investments;
means for determining, periodically, a distribution amount that is equal to or greater than a distribution amount of a prior period based upon a performance level of at least one of the investments;
means for selling a portion of the first one of the investments sufficient to fund the distribution amount if the determined distribution amount is greater than the distribution amount of the prior period; and
means for selling a portion of the first one of the investments in an amount based on any growth in value of the first one of the investments to fund a first part of the distribution amount and selling a portion of the second one of the investments sufficient to fund a second part of the distribution amount such that the first part and second part sum to equal the determined distribution amount, if the amount, if any, of the first one of the investments is less than the determined distribution amount.

111. The apparatus of 110 wherein the investments are selected from a set of investments and wherein the set of investments is determined based upon a plurality of historical performance factors including a downside deviation rating, a Sortino ratio, an upside potential ratio, and a downside risk-adjusted return rating.

112. The apparatus of 111 wherein the set of investments is limited to investments with a downside deviation rating smaller than the average downside deviation rating of all investments that have historically performed above a predefined threshold.

113. The apparatus of 111 wherein the set of investments is limited to investments that have a Sortino ratio larger than an average Sortino ratio of all investments that have historically performed above a predefined threshold.

114. The apparatus of 111 wherein the set of investments is limited to investments that have an upside potential ratio larger than an average upside potential ratio of all investments that have historically performed above a predefined threshold.

115. The apparatus of 111 wherein the set of investments is limited to investments that have a downside risk-adjusted return rating larger than an average downside risk-adjusted return rating of all investments that have historically performed above a predefined threshold.

116. An apparatus comprising:
means for investing in at least one income generating investment;
means for investing in at least one principal protection investment; and
means for drawing a periodic distribution amount from the investments based upon a withdrawal percentage of a value of the at least one income generating investment, the periodic distribution amount being equal to or greater than all prior periodic distribution amounts,
wherein the distribution is funded first by
selling a portion of the at least one income generating investment, and second by
selling a portion of the at least one principal protection investment if the withdrawal percentage of the value of the at least one income generating investment is insufficient to fund the periodic distribution amount.

117. The apparatus of claim 116 wherein the periodic distribution amount is determined based upon the value of the at least one income generating investment at the end of a period, the withdrawal percentage, and a prior periodic distribution amount.

118. The apparatus of claim 116 wherein the periodic distribution amount is equal to the withdrawal percentage of the value of the at least one income generating investment at the end of a period unless the withdrawal percentage of the value of the at least one income generating investment at the end of the period is less than the prior periodic distribution amount, in which case the prior periodic distribution amount is used as the periodic distribution amount.

119. The apparatus of claim 1 17 wherein the periodic distribution amount is equal to MAX(P′,(V*W)) wherein P′ represents the prior periodic distribution amount, V represents the value of the at least one income generating investment at the end of the period, and W represents the withdrawal percentage.

120. The apparatus of claim 117 wherein selling a portion of the at least one principal protection investment includes selling a sufficient quantity of the principal protection investment to generate funds sufficient to equal a difference between the prior periodic distribution amount and the withdrawal percentage multiplied by the value of the at least one income generating investment at the end of the period.

121. The apparatus of claim 116 wherein the periodic distribution amount is determined based upon the value of the at least one income generating investment at the end of a period, the withdrawal percentage, a prior periodic distribution amount, a withdrawal restriction amount, and a highest periodic distribution amount of all prior periods without regard to any withdrawal restrictions.

122. The apparatus of claim 116 wherein the periodic distribution amount is equal to the withdrawal percentage of the value of the at least one income generating investment at the end of a period unless,
the withdrawal percentage of the value of the at least one income generating investment at the end of the period is less than the prior periodic distribution amount, in which case the prior periodic distribution amount is used as the periodic distribution amount, or
the withdrawal percentage of the value of the at least one income generating investment at the end of the period is greater than a withdrawal restriction amount, in which case a greater of the prior distribution amount and the withdrawal restriction amount is used as the periodic distribution amount, or
the value of the at least one income generating investment at the end of the period is greater than it has been at the end of all prior periods, in which case a greater of the prior distribution amount and the withdrawal restriction amount is used as the periodic distribution amount unless,
the withdrawal percentage of a highest value of the at least one income generating investment at the end of all prior periods is less than the withdrawal restriction amount, in which case a greater of the prior distribution amount and the withdrawal percentage of the highest value of the at least one income generating investment at the end of all prior periods is used as the periodic distribution amount.

123. The apparatus of claim 122 wherein the withdrawal restriction amount is determined based upon the prior periodic distribution amount summed with a product of multiplying the prior periodic distribution amount and a withdrawal cap percentage.

124. The apparatus of 121, wherein the periodic distribution amount is equal to MAX(P,MN(H,R))), wherein P represents the prior periodic distribution amount, H represents the highest periodic distribution amount of all prior periods without regard to any withdrawal restrictions, and R represents the withdrawal restriction amount.

125. The apparatus of claim 124, wherein the highest periodic distribution amount of all prior periods without regard to any withdrawal restrictions (H) equals MAX(P′,(V*W)) wherein P′ represents the prior periodic distribution amount determined without regard to any withdrawal restrictions, V represents the value of the at least one income generating investment, and W represents the withdrawal percentage.

126. The apparatus of claim 125, wherein the prior periodic distribution amount determined without regard to any withdrawal restrictions (P′) equals (V′*W) wherein V′ represents a highest value of the at least one income generating investment at the end of all prior periods

127. The apparatus of claim 124, wherein the withdrawal restriction amount (R) is equal to P*(C+1) wherein C represents a withdrawal cap percentage.

128. The apparatus of claim 121 wherein selling a portion of the at least one principal protection investment includes selling a sufficient quantity of the principal protection investment to generate funds sufficient to equal a difference between the periodic distribution amount and the value of the at least one income generating investment at the end of the period multiplied by the withdrawal percentage, if the value of the at least one income generating investment multiplied by the withdrawal percentage is less than the periodic distribution amount.

129. The apparatus of claim 116 wherein the periodic distribution amount is determined based upon an initial value of the at least one income generating investment, the withdrawal percentage, and a cost of living adjustment amount.

130. The apparatus of claim 116 wherein the periodic distribution amount is equal to a prior periodic distribution amount summed with a product of multiplying the prior periodic distribution amount and a cost of living adjustment amount.

131. The apparatus of claim 116 wherein the periodic distribution amount is determined based upon a prior periodic distribution amount and a dynamic percentage raise amount.

132. The apparatus of claim 116 wherein the periodic distribution amount is determined based upon a prior periodic distribution amount and a percentage raise amount.

133. The apparatus of claim 132 wherein selling a portion of the at least one principal protection investment includes selling a sufficient quantity of the principal protection investment to generate funds sufficient to equal a difference between
the prior periodic distribution amount multiplied by the percentage raise amount and
the withdrawal percentage of the value of the at least one income generating investment at an end of the prior period.

134. The apparatus of claim 132 wherein selling a portion of the at least one principal protection investment includes selling a sufficient quantity of the principal protection investment to generate funds sufficient to equal the difference between
the prior periodic distribution amount multiplied by the percentage raise amount and
a withdrawal factor multiplied by a current value of the at least one income generating investment.

135. The apparatus of claim 116 wherein the periodic distribution amount is determined based upon the value of the at least one income generating investment at the end of a period, the withdrawal percentage, a prior periodic distribution amount, and a withdrawal restriction amount.

136. The apparatus of claim 116 wherein the periodic distribution amount is equal to the withdrawal percentage of the value of the at least one income generating investment at the end of a period unless either,
the withdrawal percentage of the value of the at least one income generating investment at the end of the period is less than a prior periodic distribution amount, in which case the prior periodic distribution amount is used as the periodic distribution amount, or
the withdrawal percentage of the value of the at least one income generating investment at the end of the period is more than a withdrawal restriction amount, in which case the withdrawal restriction amount is used as the periodic distribution amount.

137. The apparatus of claim 136 wherein the withdrawal restriction amount is determined based upon the prior periodic distribution amount summed with a product of multiplying the prior periodic distribution amount and a withdrawal cap percentage.

138. The apparatus of 135, wherein the periodic distribution amount is equal to MAX(P,MIN(V*W,R))), wherein P represents the prior periodic distribution amount, V represents the value of the at least one income generating investment at the end of the period, W represents the withdrawal percentage, and R represents the withdrawal restriction amount.

139. The apparatus of claim 138, wherein the withdrawal restriction amount (R) is equal to P*(C+1) wherein C represents a withdrawal cap percentage.

140. The apparatus of claim 135 wherein selling a portion of the at least one principal protection investment includes selling a sufficient quantity of the principal protection investment to generate funds sufficient to equal a difference between the periodic distribution amount and the withdrawal percentage of the value of the at least one income generating investment at the end of the period, if the withdrawal percentage of the value of the at least one income generating investment at the end of the period is less than the periodic distribution amount.

141. An apparatus comprising:
means for determining an investment amount for purchasing an investment;
means for determining a minimum distribution rate;
means for allocating the investment amount among a plurality of individual investments of different types, collectively referred to as the investment, based upon predefined ratios and historical performance information;
means for determining a distribution amount based upon a performance level of at least one of the plurality of individual investments and the minimum distribution rate; and
means for determining at least a portion of at least one individual investment from among the plurality of individual investments to liquidate to fund the distribution amount,
wherein the minimum distribution rate is never decreased and the distribution amount is paid out indefinitely as long as the investment performs no worse than the historical performance information indicates.

142. The apparatus of claim 141 wherein the predefined ratios are determined based upon historical investment data.

143. The apparatus of claim 141 wherein the predefined ratios are determined such that the minimum distribution rate can be maintained for longer than a predefined term if, based upon historical investment data, the investment performs at least equal to the investment's worst performance over a term prior to purchase and having a length determined based upon the predefined term.

144. The apparatus of claim 143 wherein the predefined term is approximately at least 30 years.

145. The apparatus of claim 141 wherein the predefined ratios are determined such that the minimum distribution rate can be maintained indefinitely if, based upon historical investment data, the plurality of individual investments collectively performs at least equal to the plurality of individual investments' worst prior performance.

147. The apparatus of claim 141 wherein the different types include at least five different types, the investment amount is allocated between the different types based upon a predefined ratio, and one of the types is characterized by an investment philosophy that is contrary to an investment philosophy of others of the types.

148. The apparatus of claim 147, wherein the different types include large capitalization value investments, balanced hybrid investments, global value growth investments, large capitalization growth investments, and bond investments.

149. The apparatus of claim 148, wherein the investment amount is allocated between bond investments and the others of the types of investments based on a ratio of approximately 4:21.

150. The apparatus of claim 149, wherein approximately 86% of the investment amount is allocated among the other types of investments based on predefined percentages including: approximately 41% allocated to large capitalization value investments, approximately 30% allocated to balanced hybrid investments, approximately20% allocated to global value growth investments, and approximately 9% allocated to large capitalization growth investments.

151. The apparatus of claim 141 wherein the ratio is determined such that the minimum distribution rate can be maintained for longer than a predefined term if, based upon historical investment data, the investment performs at least equal to the investment's worst prior performance over a term prior to purchase and having a length determined based upon the predefined term.

152. The apparatus of claim 151 wherein the predefined term is approximately at least 30 years.

153. The apparatus of claim 141 wherein the predefined ratios are determined such that the minimum distribution rate can be maintained indefinitely if, based upon historical investment data, the plurality of individual investments collectively performs at least equal to the plurality of individual investments' worst prior performance.

154. The apparatus of claim 141 wherein the distribution amount is paid periodically and the minimum distribution rate is determined periodically.

155. The apparatus of claim 154 wherein the distribution amount is paid out based upon a first period and the minimum distribution rate is determined based upon a second period.

156. The apparatus of claim 155 wherein the first period is monthly and the second period is annually.

157. The apparatus of claim 141 wherein the distribution amount may be increased by an adjustment amount as the minimum distribution rate changes.

158. The apparatus of claim 157 wherein the adjustment amount is limited if the current value of the investment increases to an amount greater than all prior values of the investment.

159. The apparatus of claim 141 wherein the minimum distribution rate is greater than a predefined percentage of the current value per year of the investment and is approximately at least six percent.
